(19) United States
(12) Patent Application Publication
(10) Pub. No.: US 2026/0318255 A1
(43) Pub. Date: Oct. 15, 2026

(54) APPARATUS AND METHOD FOR SUPPLYING AND PRESSURIZING GASEOUS FUEL TO AN INTERNAL COMBUSTION ENGINE

(71) Applicant: HPDI Technology Limited Partnership, Vancouver (CA)

(72) Inventors: Adrian J Post, Surrey (CA); Robbi Lynn McDonald, Richmond (CA)

(73) Assignee: HPDI Technology Limited Partnership, Vancouver, BC (CA)

(21) Appl. No.: 19/135,041

(22) PCT Filed: Dec. 6, 2023
(86) PCT No.: PCT/CA2023/051617

§ 371 Date: Jun. 2, 2025

Related U.S. Application Data
(60) Provisional application No. 63/430,657, filed on Dec. 6, 2022.

(51) Int. Cl. F02D 19/06; F02M 21/02

(52) U.S. Cl. CPC F02D 19/0605; F02D 19/061; F02D 19/0642; F02D 19/0644; F02D 19/0647; F02D 19/0665; F02D 19/0678; F02D 19/0684; F02D 19/0686; F02M 21/0224; F02M 21/0239; F02M 21/0245; F02M 21/0248

(57) ABSTRACT

An apparatus for supplying and pressurizing a gaseous fuel to an internal combustion engine includes a first supply of the gaseous fuel storing the gaseous fuel as a compressed gas at a first storage pressure; a compressor selectively pressurizing the gaseous fuel at its inlet from the first supply and providing the gaseous fuel at a pressurized pressure at its outlet; and a first pressure regulator configured to fluidly receive at its inlet the gaseous fuel from the first supply at the first storage pressure or from the compressor at the pressurized pressure, the first pressure regulator regulates a pressure of the gaseous fuel at its inlet to a first regulated pressure at its outlet, the internal combustion engine in fluid communication with the outlet to fluidly receive the gaseous fuel at the first regulated pressure.

### TECHNICAL FIELD

The present application relates to an apparatus and method for pressurizing and supplying a gaseous fuel to an internal combustion engine, and in particular a gaseous fuel stored as a compressed gas.

### BACKGROUND

Compressed natural gas (CNG) and compressed hydrogen are gaseous fuels stored under pressure in a vessel, for example a compressed gas cylinder, and are known to be used in trucking applications, and particularly in heavy duty trucks. In those applications that introduce the gaseous fuel later in the compression stroke it is known to use a compressor to maintain the pressure of the gaseous fuel above a threshold by raising the storage pressure of the CNG or CH2 in the vessel to at least a desired rail pressure or injection pressure in a fuel rail. The compressor is powered from energy produced by an internal combustion engine and operation of the compressor increases parasitic losses and reduces fuel economy of the engine. Power consumption of the compressor is a function of the pressure rise from the vessel to the fuel rail and a flow rate of gaseous fuel through the compressor.

The work required by the compressor is small or even zero when the vessel is full, but as the vessel pressure diminishes the work required by the compressor steadily increases to raise the gas pressure. A capacity of the compressor, which is related to a size of the compressor, must be selected to meet engine fuel demand during transient engine operating conditions that can exhibit large increases in engine fuel demand compared to steady state operating conditions. To supply a mass flow-rate equivalent to that required by a heavy-duty engine, the compressor must be very physically large and use significant power which are difficult to package on a vehicle. Eventually the parasitic losses from the compressor become too great for the engine to operate and an unused amount of fuel remains in the vessel.

The state of the art is lacking in techniques for supplying and pressurizing gaseous fuel to an internal combustion engine. The present apparatus and method provide a technique for improving the supply and pressurization of gaseous fuel to an internal combustion engine.

### SUMMARY

An improved apparatus for supplying and pressurizing a gaseous fuel to an internal combustion engine can include a first supply of the gaseous fuel storing the gaseous fuel as a compressed gas at a first storage pressure. There can be a compressor and a first pressure regulator. The compressor can include an inlet and an outlet, where the compressor can selectively pressurize the gaseous fuel at the inlet from the first supply and provide the gaseous fuel at a pressurized pressure at the outlet. The first pressure regulator can include an inlet and an outlet, where the inlet can be configured to fluidly receive the gaseous fuel from the first supply at the first storage pressure or from the compressor at the pressurized pressure. The first pressure regulator can regulate a pressure of the gaseous fuel at the inlet to a first regulated pressure at the outlet. The internal combustion engine can be in fluid communication with the outlet of the first pressure regulator to fluidly receive the gaseous fuel at the first regulated pressure. The gaseous fuel can be one of biogas, hydrogen, methane, natural gas, and mixtures of these gaseous fuels.

In other embodiments the apparatus can include a second supply of the gaseous fuel storing the gaseous fuel as a compressed gas at a second storage pressure, and a supply-select apparatus in fluid communication with the first supply and the second supply and actuatable to fluidly connect the first supply and the second supply selectively with the first pressure regulator or the compressor.

Alternatively, in further embodiments the apparatus can include a second pressure regulator comprising an inlet and an outlet, the inlet of the second pressure regulator can be configured to fluidly receive the gaseous fuel from the first supply at the first storage pressure or from the compressor at the pressurized pressure. The second pressure regulator can regulate a pressure of the gaseous fuel at the inlet to a second regulated pressure at the outlet. The internal combustion engine can be in fluid communication with the outlet of the second pressure regulator to fluidly receive the gaseous fuel at the second regulated pressure. There can be a delivery valve configured to selectively enable a flow of the gaseous fuel from the first pressure regulator to the internal combustion engine. The first regulated pressure can be greater than the second regulated pressure whereby when the delivery valve is in an open position the first pressure regulator can be configured to supply a high-pressure flow to the internal combustion engine and when the delivery valve is in a closed position the second pressure regulator can be configured to supply a low-pressure flow to the internal combustion engine.

Alternatively, in still further embodiments the apparatus can further include a second supply of the gaseous fuel storing the gaseous fuel as a compressed gas at a second storage pressure. There can be a second pressure regulator including an inlet and an outlet. The inlet of the second pressure regulator can be configured to fluidly receive the gaseous fuel from the first supply at the first storage pressure or from the compressor at the pressurized pressure. The second pressure regulator can regulate a pressure of the gaseous fuel at the inlet to a second regulated pressure at the outlet. The internal combustion engine can be in fluid communication with the outlet of the second pressure regulator to fluidly receive the gaseous fuel at the second regulated pressure. There can be a supply-select apparatus in fluid communication with the first supply and the second supply and actuatable to fluidly connect the first supply and the second supply selectively with the first pressure regulator, the second pressure regulator or the compressor. A delivery valve can be configured to selectively enable a flow of gaseous fuel from the first pressure regulator to the internal combustion engine. The first regulated pressure can be greater than the second regulated pressure whereby when the delivery valve is in an open position the first pressure regulator can be configured to supply a high-pressure flow to the internal combustion engine and when the delivery valve is in a closed position the second pressure regulator can be configured to supply a low-pressure flow to the internal combustion engine. In an exemplary embodiment, the first storage pressure of the first supply and the second storage pressure of the second supply are both substantially within a range of 350 bar and 700 bar when the first supply and the second supply are filled. The first supply can include one or more gas cylinders, the second supply can include one or more gas cylinders. There can be a shared gas cylinder selectively fluidly connected to the first supply or the second supply. A storage volume ratio between a volume of the first supply over a volume of the second supply can be one of 1:1, 2:1, 3:1, 4:1, 5:1, 1:2, 1:3, 1:4, 1:5, 3:2, and 2:3.

The supply-select apparatus can include at least one of the following, an automatically actuatable valve configured to fluidly connect the first supply selectively with the inlet of the first pressure regulator; an automatically actuatable valve configured to fluidly connect the second supply selectively with the inlet of the first pressure regulator; an automatically actuatable valve configured to fluidly connect the first supply selectively with the inlet of the second pressure regulator; an automatically actuatable valve configured to fluidly connect the second supply selectively with the inlet of the second pressure regulator; an automatically actuatable valve configured to fluidly connect the first supply selectively with the inlet of the compressor; an automatically actuatable valve configured to fluidly connect the second supply selectively with the inlet of the compressor; an automatically actuatable valve configured to fluidly connect the outlet of the compressor selectively with the inlet of the second pressure regulator; an automatically actuatable valve configured to fluidly connect the first supply selectively with the second supply; an automatically actuatable valve configured to selectively enable a flow of the gaseous fuel from the second pressure regulator to the internal combustion engine; a check valve configured to fluidly communicate the gaseous fuel from the first supply to the inlet of the first pressure regulator, the inlet of the second pressure regulator, and the inlet of the compressor; a check valve configured to fluidly communicate the gaseous fuel from the second supply to the inlet of the first pressure regulator, the inlet of the second pressure regulator, and the inlet of the compressor; a check valve configured to fluidly communicate the gaseous fuel from the first supply and the second supply to the inlet of the first pressure regulator; a check valve configured to fluidly communicate the gaseous fuel from the outlet of the compressor to the inlet of the first pressure regulator; a check valve configured to fluidly communicate the gaseous fuel from the first supply and the outlet of the compressor to the inlet of the first pressure regulator; a check valve configured to fluidly communicate the gaseous fuel from the first supply to the inlet of the first pressure regulator; a check valve configured to fluidly communicate the gaseous fuel from the first supply to the inlet of the second pressure regulator; a check valve configured to fluidly communicate the gaseous fuel from the first supply to the inlet of the compressor; a check valve configured to fluidly communicate the gaseous fuel from the first supply and the second supply to the inlet of the second pressure regulator; a conduit configured to fluidly connect the outlet of the compressor with the inlet of the first pressure regulator; a conduit configured to fluidly connect the outlet of the compressor, the inlet of the first pressure regulator, and the inlet of the second pressure regulator; a conduit configured to fluidly connect the inlet of the first pressure regulator and the inlet of the second pressure regulator; and a conduit configured to fluidly connect the first supply, the second supply, the inlet of the first pressure regulator, the inlet of the second pressure regulator, and the inlet of the compressor. The delivery valve can be a solenoid valve.

The compressor can be one of a reciprocating piston pump, a diaphragm pump, or a centrifugal pump. In some embodiments the compressor can be one of a single acting pump, a double acting pump, and a quad acting pump. The compressor can include one of a single stage and a plurality of stages. The compressor can be actuated hydraulically, pneumatically, mechanically, or electromagnetically. The first pressure regulator can include one of a mechanical pressure regulator, an electronically-controlled pressure regulator, and a fuel-injector-type pressure regulator; and the second pressure regulator cam include comprises one of a mechanical pressure regulator, an electronically-controlled pressure regulator, and a fuel-injector-type pressure regulator.

The embodiments of the apparatus can include at least one of a first pressure sensor configured to emit signals representative of the first storage pressure of the gaseous fuel in the first supply; a second pressure sensor configured to emit signals representative of the first storage pressure of the gaseous fuel in the first supply; a third pressure sensor configured to emit signals representative of the pressurized pressure at the outlet of compressor; and a fourth pressure sensor configured to emit signals representative of a delivery pressure of the gaseous fuel supplied to the internal combustion engine from the first pressure regulator and the second pressure regulator. A controller can be programmed to receive at least one of the signals from the first pressure sensor; the signals from the second pressure sensor; the signals from the third pressure sensor; and the signals from the fourth pressure sensor; and programmed to determine at least one of the first storage pressure based on the respective signals from the first pressure sensor; the second storage pressure based on the respective signals from the second pressure sensor; the pressurized pressure based on the respective signals from the third pressure sensor; and the delivery pressure based on the respective signals from the fourth pressure sensor.

The embodiments of the apparatus can include a controller operatively connected with the supply-select apparatus, the compressor, and the delivery valve. The controller can be programmed to compare the first storage pressure of the first supply with an upper threshold pressure; when the first storage pressure of the first supply is greater than the upper threshold pressure, command a first stage of operation by providing a high-pressure flow of the gaseous fuel without compression from the first supply to the internal combustion engine through the first pressure regulator; when the first storage pressure of the first supply is less than or equal the upper threshold pressure, compare the first storage pressure with a lower threshold pressure and compare the delivery pressure with the first regulated pressure; when the first storage pressure is greater than the lower threshold pressure and the delivery pressure is greater than or equal to the first regulated pressure, command a second stage of operation by providing a high-pressure flow of the gaseous fuel with compression from the first supply to the internal combustion engine through the compressor and the first pressure regulator; when the first storage pressure is less than or equal to the lower threshold pressure or the delivery pressure is less than the first regulated pressure, compare the second storage pressure of the second supply with the upper threshold pressure; when the second storage pressure is greater than the upper threshold pressure, command a third stage of operation by providing a high-pressure flow of the gaseous fuel without compression from the second supply to the internal combustion engine through the second pressure regulator; when the second storage pressure is less than or equal to the upper threshold pressure, compare the second storage pressure of the second supply with the lower threshold pressure; and when the second storage pressure is greater than the lower threshold pressure, command a fourth stage of operation by providing a high-pressure flow of the gaseous fuel with compression from the second supply to the internal combustion engine through the compressor and the first pressure regulator. The upper threshold pressure can be a function of a combustion mode of the internal combustion engine and the gaseous fuel, and the lower threshold pressure can be a function of a compression ratio of the compressor and the first regulated pressure of the first pressure regulator. The first regulated pressure can be within a range of 200 bar to 600 bar, and the second regulated pressure is within a range of 50 bar to 300 bar.

In exemplary embodiments, during the second stage of operation providing the high-pressure flow with compression from the first supply or the fourth stage of operation providing the high-pressure flow with compression from the second supply, the compressor can be sized whereby the internal combustion engine can operate up to a low-threshold-pressure power. The low-threshold-pressure power can be one of 75% of a maximum rated power of the internal combustion engine; 50% of a maximum rated power of the internal combustion engine; and 25% of a maximum rated power of the internal combustion engine.

Before determining whether the first stage, the second stage, the third stage, and the fourth stage of operation are to be commanded, the controller can be further programmed to compare a power of the internal combustion engine with a low-pressure-flow threshold power and the first storage pressure of the first supply with the second regulated pressure; when the power of the internal combustion engine is less than the low-pressure-flow threshold power and the first storage pressure is greater than the second regulated pressure, command a fifth stage of operation by providing a low-pressure flow of the gaseous fuel without compression from the first supply to the internal combustion engine through the second pressure regulator; when the power of the internal combustion engine is less than the low-pressure-flow threshold power and the first storage pressure is less than or equal to the second regulated pressure, compare the second storage pressure of the second supply with the second regulated pressure, when the second storage pressure of the second supply is greater than the second regulated pressure, command a sixth stage of operation by providing a low-pressure flow of the gaseous fuel without compression from the second supply to the internal combustion engine through the second pressure regulator.

After determining whether the fifth stage and the sixth stage of operation are to be commanded and before determining whether the first stage, the second stage, the third stage, and the fourth stage of operation are to be commanded, the controller can be further programmed to, when the power of the internal combustion engine is less than the low-pressure-flow threshold power and the second storage pressure is less than or equal to the second regulated pressure, compare the first storage pressure with a second lower-threshold pressure; when the first storage pressure is greater than the second lower-threshold power, command a seventh stage of operation by providing a low-pressure flow of the gaseous fuel with compression from the first supply to the internal combustion engine through the compressor and the second pressure regulator; when the power of the internal combustion engine is less than the low-pressure-flow threshold power and the first storage pressure is less than or equal to the second lower-threshold power, compare the second storage pressure with the second lower-threshold pressure; and when the second storage pressure is greater than the second lower-threshold power, command an eighth stage of operation by providing a low-pressure flow of the gaseous fuel with compression from the second supply to the internal combustion engine through the compressor and the second pressure regulator.

After determining whether the fifth stage of operation is to be commanded and before determining whether the sixth stage, the first stage, the second stage, the third stage, and the fourth stage of operation are to be commanded, the controller can be further programmed to, when the power of the internal combustion engine is less than the low-pressure-flow threshold power and the second storage pressure is less than or equal to the second regulated pressure, compare the first storage pressure with a second lower-threshold pressure; when the first storage pressure is greater than the second lower-threshold power, command a seventh stage of operation by providing a low-pressure flow of the gaseous fuel with compression from the first supply to the internal combustion engine through the compressor and the second pressure regulator.

After determining whether the fifth stage, the seventh stage, and the sixth stage of operation are to be commanded and before determining whether the first stage, the second stage, the third stage, and the fourth stage of operation are to be commanded, the controller can be further programmed to, when the power of the internal combustion engine is less than the low-pressure-flow threshold power and the first storage pressure is less than or equal to the second lower-threshold power, compare the second storage pressure with the second lower-threshold pressure; and when the second storage pressure is greater than the second lower-threshold power, command an eighth stage of operation by providing a low-pressure flow of the gaseous fuel with compression from the second supply to the internal combustion engine through the compressor and the second pressure regulator.

In an exemplary embodiment, when the sixth stage of operation is commanded, the controller can be further programmed to compare the first storage pressure with a second lower-threshold pressure; and when the first storage pressure is greater than the second lower-threshold pressure, command a ninth stage of operation by providing a low-pressure flow of the gaseous fuel with compression from the first supply to the internal combustion engine through the compressor and the second pressure regulator and combining with the low-pressure flow of the gaseous fuel without compression from the second supply to the internal combustion engine through the second pressure regulator commanded in the sixth stage of operation. During the ninth stage of operation the low-pressure flow of the gaseous fuel with compression from the first supply includes up to one of 100% of a total flow of the gaseous fuel to the internal combustion engine; 75% of the total flow of the gaseous fuel to the internal combustion engine; 50% of the total flow of the gaseous fuel to the internal combustion engine; and 25% of the total flow of the gaseous fuel to the internal combustion engine; where the total flow of the gaseous fuel is a combined flow of the low-pressure flow with compression from the first supply and the low-pressure flow without compression from the second supply. The second lower-threshold pressure can be a function of a compression ratio of the compressor and the second regulated pressure of the second pressure regulator. Alternatively, or additionally, when the sixth stage of operation is commanded, the controller can be further programmed to compare the first storage pressure with a second lower-threshold pressure; and when the first storage pressure is greater than the second lower-threshold pressure, command a ninth stage of operation by pressurizing gaseous fuel drawn from the first supply into a conduit in fluid communication with the outlet of the compressor.

In another exemplary embodiment, when the third stage of operation is commanded, the controller can be further programmed to compare the first storage pressure with the lower threshold pressure; and when the first storage pressure is greater than the lower threshold pressure, command a tenth stage of operation by providing a high-pressure flow of the gaseous fuel with compression from the first supply to the internal combustion engine through the compressor and the first pressure regulator and combining with the high-pressure flow of the gaseous fuel without compression from the second supply to the internal combustion engine through the first pressure regulator commanded in the third stage of operation. During the tenth stage of operation the high-pressure flow of the gaseous fuel with compression from the first supply can include up to one of 100% of a total flow of the gaseous fuel to the internal combustion engine; 75% of the total flow of the gaseous fuel to the internal combustion engine; 50% of the total flow of the gaseous fuel to the internal combustion engine; and 25% of the total flow of the gaseous fuel to the internal combustion engine, where the total flow of the gaseous fuel is a combined flow of the high-pressure flow with compression from the first supply and the high-pressure flow without compression from the second supply. Alternatively, or additionally, when the third stage of operation is commanded, the controller can be further programmed to compare the first storage pressure with the lower threshold pressure; and when the first storage pressure is greater than the lower threshold pressure, command a tenth stage of operation by pressurizing gaseous fuel drawn from the first supply into a conduit in fluid communication with the outlet of the compressor.

An improved method for supplying and pressurizing a gaseous fuel to an internal combustion engine includes storing the gaseous fuel in a first supply a compressed gas at a first storage pressure; storing the gaseous fuel in a second supply as a compressed gas at a second storage pressure; comparing the first storage pressure of the first supply with an upper threshold pressure; when the first storage pressure of the first supply is greater than the upper threshold pressure, commanding a first stage of operation by providing a high-pressure flow of the gaseous fuel without compression from the first supply to the internal combustion engine; when the first storage pressure of the first supply is less than or equal the upper threshold pressure, comparing the first storage pressure with a lower threshold pressure and comparing a delivery pressure of the gaseous fuel to the internal combustion engine with the first regulated pressure; when the first storage pressure is greater than the lower threshold pressure and the delivery pressure is greater than or equal to the first regulated pressure, commanding a second stage of operation by providing a high-pressure flow of the gaseous fuel with compression from the first supply to the internal combustion engine; when the first storage pressure is less than or equal to the lower threshold pressure or the delivery pressure is less than the first regulated pressure, comparing the second storage pressure of the second supply with the upper threshold pressure; when the second storage pressure is greater than the upper threshold pressure, commanding a third stage of operation by providing a high-pressure flow of the gaseous fuel without compression from the second supply to the internal combustion engine; when the second storage pressure is less than or equal to the upper threshold pressure, comparing the second storage pressure of the second supply with the lower threshold pressure; and when the second storage pressure is greater than the lower threshold pressure, commanding a fourth stage of operation by providing a high-pressure flow of the gaseous fuel with compression from the second supply to the internal combustion engine.

Before determining whether the first stage, the second stage, the third stage, and the fourth stage of operation are to be commanded, the method can further include comparing a power of the internal combustion engine with a low-pressure-flow threshold power and the first storage pressure of the first supply with the second regulated pressure; when the power of the internal combustion engine is less than the low-pressure-flow threshold power and the first storage pressure is greater than the second regulated pressure, commanding a fifth stage of operation by providing a low-pressure flow of the gaseous fuel without compression from the first supply to the internal combustion engine; when the power of the internal combustion engine is less than the low-pressure-flow threshold power and the first storage pressure is less than or equal to the second regulated pressure, comparing the second storage pressure of the second supply with the second regulated pressure, when the second storage pressure of the second supply is greater than the second regulated pressure, commanding a sixth stage of operation by providing a low-pressure flow of the gaseous fuel without compression from the second supply to the internal combustion engine.

After determining whether the fifth stage and the sixth stage of operation are to be commanded and before determining whether the first stage, the second stage, the third stage, and the fourth stage of operation are to be commanded, the method can further include, when the power of the internal combustion engine is less than the low-pressure-flow threshold power and the second storage pressure is less than or equal to the second regulated pressure, comparing the first storage pressure with a second lower-threshold pressure; when the first storage pressure is greater than the second lower-threshold power, commanding a seventh stage of operation by providing a low-pressure flow of the gaseous fuel with compression from the first supply to the internal combustion engine; when the power of the internal combustion engine is less than the low-pressure-flow threshold power and the first storage pressure is less than or equal to the second lower-threshold power, comparing the second storage pressure with the second lower-threshold pressure; and when the second storage pressure is greater than the second lower-threshold power, commanding an eighth stage of operation by providing a low-pressure flow of the gaseous fuel with compression from the second supply to the internal combustion engine.

After determining whether the fifth stage of operation is to be commanded and before determining whether the sixth stage, the first stage, the second stage, the third stage, and the fourth stage of operation are to be commanded, the method can further include, when the power of the internal combustion engine is less than the low-pressure-flow threshold power and the second storage pressure is less than or equal to the second regulated pressure, comparing the first storage pressure with a second lower-threshold pressure; when the first storage pressure is greater than the second lower-threshold power, commanding a seventh stage of operation by providing a low-pressure flow of the gaseous fuel with compression from the first supply to the internal combustion engine.

After determining the fifth stage, the seventh stage, and the sixth stage of operation are to be commanded and before determining whether the first stage, the second stage, the third stage, and the fourth stage of operation are to be commanded, the method can further include, when the power of the internal combustion engine is less than the low-pressure-flow threshold power and the first storage pressure is less than or equal to the second lower-threshold power, comparing the second storage pressure with the second lower-threshold pressure; and when the second storage pressure is greater than the second lower-threshold power, commanding an eighth stage of operation by providing a low-pressure flow of the gaseous fuel with compression from the second supply to the internal combustion engine.

In an exemplary embodiment, when the sixth stage of operation is commanded, the method can further include comparing the first storage pressure with a second lower-threshold pressure; and when the first storage pressure is greater than the second lower-threshold pressure, commanding a ninth stage of operation by providing a low-pressure flow of the gaseous fuel with compression from the first supply to the internal combustion engine and combining with the low-pressure flow of the gaseous fuel without compression from the second supply to the internal combustion engine commanded in the sixth stage of operation. During the ninth stage of operation the low-pressure flow of the gaseous fuel with compression from the first supply can include up to one of 100% of a total flow of the gaseous fuel to the internal combustion engine; 75% of the total flow of the gaseous fuel to the internal combustion engine; 50% of the total flow of the gaseous fuel to the internal combustion engine; and 25% of the total flow of the gaseous fuel to the internal combustion engine; where the total flow of the gaseous fuel is a combined flow of the low-pressure flow with compression from the first supply and the low-pressure flow without compression from the second supply. Alternatively, or additionally, when the sixth stage of operation is commanded, the method can further include comparing the first storage pressure with a second lower-threshold pressure; and when the first storage pressure is greater than the second lower-threshold pressure, commanding a ninth stage of operation by pressurizing gaseous fuel drawn from the first supply into a conduit.

In another exemplary embodiment, when the third stage of operation is commanded, the method can further include comparing the first storage pressure with the lower threshold pressure; and when the first storage pressure is greater than the lower threshold pressure, commanding a tenth stage of operation by providing a high-pressure flow of the gaseous fuel with compression from the first supply to the internal combustion engine and combining with the high-pressure flow of the gaseous fuel without compression from the second supply to the internal combustion engine commanded in the third stage of operation.

During the tenth stage of operation the high-pressure flow of the gaseous fuel with compression from the first supply can include up to one of 100% of a total flow of the gaseous fuel to the internal combustion engine; 75% of the total flow of the gaseous fuel to the internal combustion engine; 50% of the total flow of the gaseous fuel to the internal combustion engine; and 25% of the total flow of the gaseous fuel to the internal combustion engine, where the total flow of the gaseous fuel is a combined flow of the high-pressure flow with compression from the first supply and the high-pressure flow without compression from the second supply. Alternatively, or additionally, when the third stage of operation is commanded, the method can further include comparing the first storage pressure with the lower threshold pressure; and when the first storage pressure is greater than the lower threshold pressure, commanding a tenth stage of operation by pressurizing gaseous fuel drawn from the first supply into a conduit.

Any of the embodiments and methods described herein can also optionally include a controller programmed to actuate any one or more of the supply-select apparatus, the compressor, and the delivery valve to fluidly connect the first supply and/or the second supply with the first pressure regulator, the second pressure regulator or the compressor as a function of a determined duty cycle for the engine. Any of the embodiments and methods described herein can also optionally include a controller programmed to actuate a valve fluidly connected to a shared gas cylinder to selectively fluidly connect to the first supply or the second supply to set the storage volume ratio between a volume of the first supply over a volume of the second supply as a function of any one or more of a distance and/or time to a high load requirement, a geographical location, a time to system shut down, and a time to system refueling. Any of the embodiments and methods described herein can also optionally include a controller programmed to select an order of each stage of operation to optimize for a determined duty cycle for the engine.

Any of the embodiments and methods described herein can also include a vehicle operation system equipped with either an integrated or a separate programmable vehicle data system which communicates with the controller to optimize the supplying and pressurizing of gaseous fuel to the engine. The system can include an onboard vehicle data system either integrated with or configured to transmit data to and receive data from the controller programmed to control the supply and pressurizing of gaseous fuel to the engine. The embodiments and methods herein can further optionally include the controller commanding an order of each stage of operation disclosed herein as a function of any one or more of a determined duty cycle for the engine, an operator preference, a learned operator pattern, and a system use pattern. The embodiments and methods herein can further optionally include the controller actuating a valve fluidly connecting one or more of a shared gas cylinder to selectively fluidly connect the one or more shared gas cylinder to a first fuel supply or a second fuel supply thereby setting a storage volume ratio between a volume of the first supply over a volume of the second supply as a function of any one or more of a determined duty cycle for the engine, an operator preference, a learned operator pattern, and a system use pattern. The embodiments and methods herein can further optionally include the controller actuating a valve fluidly connecting a shared gas cylinder to selectively fluidly connect the shared gas cylinder to a first fuel supply or a second fuel supply thereby setting a storage volume ratio between a volume of the first fuel supply over a volume of the second fuel supply as a function of any one or more of a distance and/or a time to a high load requirement, a geographical location, a system shut down, and a system refueling.

### BRIEF DESCRIPTION OF THE DRAWINGS

The accompanying drawings, which are incorporated into and constitute a part of the specification, illustrate exemplary embodiments of the apparatus, systems, and methods and, together with the general description above, and the detailed description of the embodiments, serve to explain the principles of the apparatus, systems, and methods. In the figures, like reference numbers refer to like elements or acts throughout the figures.

FIG. 1 is a schematic view of a gaseous-fuel system for supplying and pressurizing gaseous fuel to an internal combustion engine according to an embodiment.

FIG. 2 is a schematic view of a gaseous-fuel system for supplying and pressurizing gaseous fuel to an internal combustion engine according to an embodiment.

FIG. 3 is a schematic view of a gaseous-fuel system for supplying and pressurizing gaseous fuel to an internal combustion engine according to an embodiment.

FIG. 4 is a schematic view of a gaseous-fuel system for supplying and pressurizing gaseous fuel to an internal combustion engine according to an embodiment.

FIG. 5 is a schematic view of a gaseous-fuel system for supplying and pressurizing gaseous fuel to an internal combustion engine according to an embodiment.

FIG. 6 is a schematic view of a gaseous-fuel system for supplying and pressurizing gaseous fuel to an internal combustion engine according to an embodiment.

FIG. 7 is a schematic view of a gaseous-fuel system for supplying and pressurizing gaseous fuel to an internal combustion engine according to an embodiment.

FIG. 8 is a schematic view of a gaseous-fuel system for supplying and pressurizing gaseous fuel to an internal combustion engine according to an embodiment.

FIG. 9 is a schematic view of a first supply of gaseous fuel and a second supply of gaseous fuel for the gaseous-fuel systems of FIGS. 1, 2, 3, 4, 5, 6, 7, and 8 according to several embodiments of storage volume ratios between a volume of the first supply over a volume of the second supply.

FIG. 10 is a schematic view of a first supply of gaseous fuel and a second supply of gaseous fuel for the gaseous-fuel systems of FIGS. 1, 2, 3, 4, 5, 6, 7, and 8 where a gas cylinder is selectively part of the first supply or the second supply according to several embodiments of storage volume ratios between a volume of the first supply over a volume of the second supply.

FIG. 11 is a flow chart view of a technique of operating the gaseous-fuel system of FIGS. 1, 2, 3, 4, 5, 6, 7, and 8 according to an embodiment.

FIG. 12 is a flow chart view of a technique of operating the gaseous-fuel system of FIGS. 1, 2, 3, 4, 5, 6, 7, and 8 according to another embodiment.

FIG. 13 is a flow chart view of a technique of operating the gaseous-fuel system of FIGS. 1, 2, 3, 4, 5, 6, 7, and 8 according to another embodiment.

FIGS. 14 and 15 are flow chart views of a technique of operating the gaseous-fuel system of FIGS. 1, 2, 3, 4, 5, 6, 7, and 8 according to another embodiment.

FIGS. 16 and 17 are flow chart views of a technique of operating the gaseous-fuel system of FIGS. 1, 2, 3, 4, 5, 6 and 7 according to another embodiment.

### DETAILED DESCRIPTION

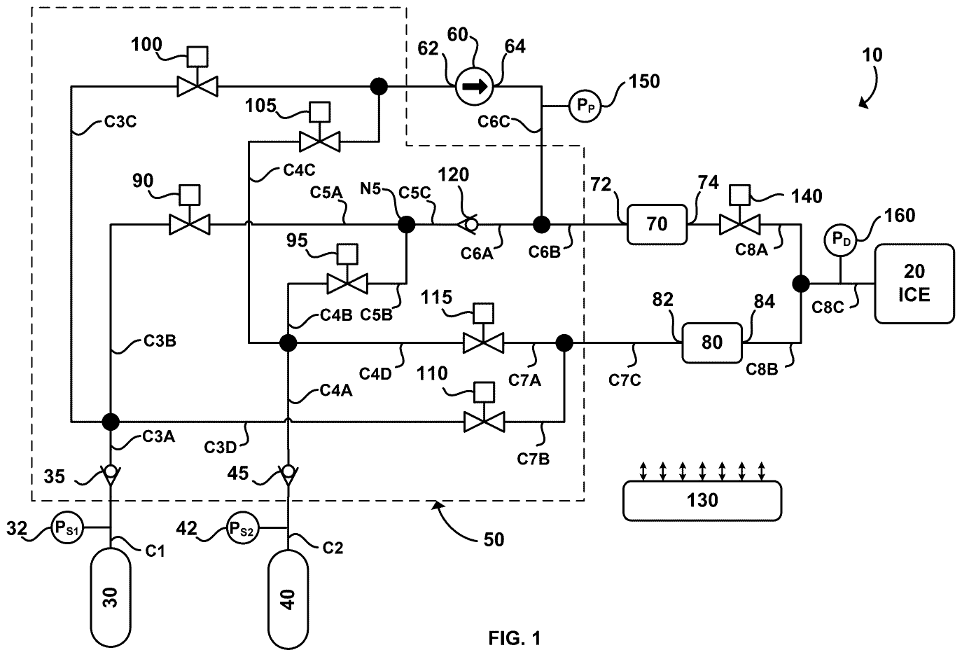

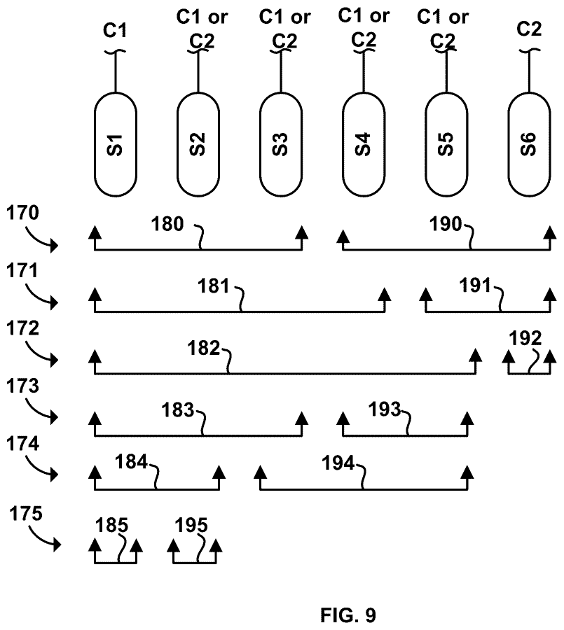

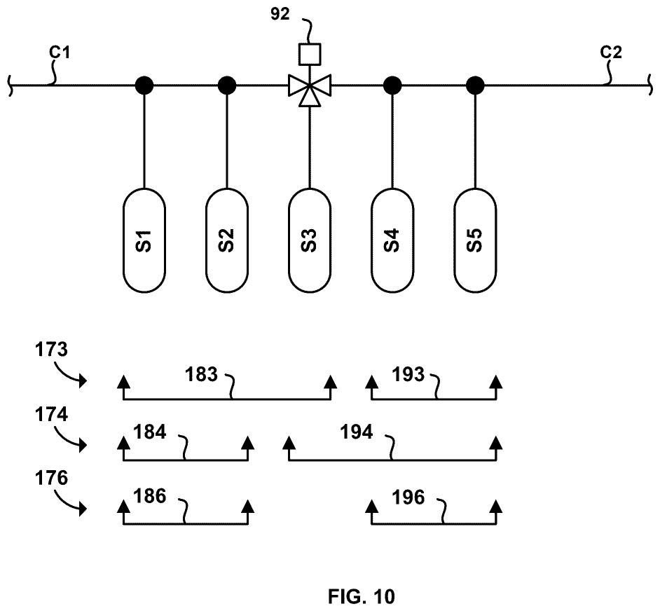

Referring to FIG. 1, there is shown gaseous-fuel system 10 for supplying and pressurizing gaseous fuel to fuel consumer 20, which can be an internal combustion engine, or more particularly a fuel injection system (not shown) of the internal combustion engine, according to an embodiment. As used herein, a gaseous fuel is any fuel that is in the gas state (phase) at standard temperature and pressure, which in the context of this application is zero degrees Celsius (0 °C) and one hundred kilopascals (100 kPa), respectively. The gaseous fuel herein can be a single gaseous fuel or a mixture of gaseous fuels. Exemplary gaseous fuels include but are not limited to biogas, hydrogen, methane, naturals gas, and mixtures thereof. Gaseous-fuel system 10 includes first supply 30 of the gaseous fuel and second supply 40 of the gaseous fuel, both of which store the gaseous fuel as a compressed gas. Preferably, the type of gaseous fuel stored in first supply 30 and second supply 40 is the same although this is not a requirement. A storage volume of first supply 30 can be greater than, equal to, or less than a storage volume of second supply 40, and accordingly the first supply can store a greater mass, an equal mass, or a lesser mass of gaseous fuel compared to the second supply at any given storage pressure and temperature. For each of the first supply 30 and the second supply 40, a typical storage pressure range is between 350 bar to 700 bar after filling; however, different storage pressures after filling (both higher and lower) are contemplated. In an exemplary embodiment a storage volume ratio between the storage volume of first supply 30 over the storage volume of second supply 40 can be in a range of 3:2; however, other storage volume ratios are contemplated as will be discussed in more detail below with respect to FIGS. 9 and 10. First supply 30 can include one or more gas cylinders as storage vessels that can be connected in serial and/or in parallel arrangements. Similarly, second supply 40 can include one or more gas cylinders as storage vessels that can be connected in serial and/or in parallel arrangements. The term “and/or” is used herein to mean “one or the other or both.” A gas cylinder is a pressure vessel for storage and containment of gaseous fluids at above atmospheric pressure. High-pressure gas cylinders are also called bottles. In the illustrated embodiments, the contents inside the gas cylinders are compressed above atmospheric pressure and in the gas state. A typical gas cylinder design can be elongated and can be lying horizontal or standing upright in a rack, with the valve and fitting at one end or the top, respectively, for connecting to the receiving apparatus. Gaseous fuel system 10 supplies the gaseous fuel stored in first supply 30 at first storage pressure P_{S1} or second supply 40 at second storage pressure P_{S2} to fuel consumer 20 at delivery pressure P_{D}. It is noteworthy that in some embodiments fuel consumer 20 can further regulate the pressure of the gaseous fuel from the delivery pressure P_{D} to another pressure, for example a fuel injection pressure of the fuel injection system (not shown).

Typically, fuel consumer 20 is supplied with the gaseous fuel at delivery pressure P_{D} (through conduit C8 in FIG. 1) either from first supply 30 or from second supply 40 at any one time (although modes of operation where both the first and second supplies supply the gaseous fuel to the fuel consumer simultaneously are contemplated). Delivery pressure P_{D} can be a first regulated pressure P_{1R} or a second regulated pressure P_{2R} where the first regulated pressure P_{1R} is greater than the second regulated pressure P_{2R}. In exemplary embodiments, the first regulated pressure P_{1R} can be in a range of 200 to 600 bar and the second regulated pressure P_{2R} can be in a range of 50 to 300 bar; although other pressure ranges are contemplated for both the first and second regulated pressures P_{1R} and P_{2R}, respectively, depending upon the application. As will be discussed in this disclosure, the gaseous fuel from first supply 30 can be down regulated to the first regulated pressure P_{1R} or in some embodiments herein to the second regulated pressure P_{2R} from the first storage pressure P_{S1} of first supply 30, or the gaseous fuel from first supply 30 can be first pressurized from the first storage pressure P_{S1} in first supply 30 to a pressurized pressure P_{P} (in conduit C6 in FIG. 1) and the pressurized pressure P_{P} of the gaseous fuel can then be down regulated to the first regulated pressure P_{1R}, or in some embodiments herein to the second regulated pressure P_{2R}. Similarly, the gaseous fuel from second supply 40 can be down regulated to the first regulated pressure P_{1R} or in some embodiments herein to the second regulated pressure P_{2R} from the second storage pressure P_{S2} of second supply 40, or the gaseous fuel from second supply 40 can be first pressurized from the second storage pressure P_{S2} in second supply 40 to the pressurized pressure P_{P} and the pressurized pressure P_{P} of the gaseous fuel can then be down regulated to the first regulated pressure P_{1R}, or in some embodiments herein to the second regulated pressure P_{2R}.

Returning to FIG. 1, gaseous-fuel system 10 includes supply-select apparatus 50, compressor 60, first pressure regulator 70, and second pressure regulator 80. Each of these items are discussed in turn. Supply-select apparatus 50 can be employed to (i) select which one of first supply 30 or second supply 40 to supply fuel consumer 20 with the gaseous fuel, (ii) select whether the pressure of the gaseous fuel is down regulated from the first storage pressure P_{S1} in first supply 30 or the second storage pressure P_{S2} in second supply 40 or down regulated from the pressurized pressure P_{P} of the gaseous fuel, (iii) select whether the first regulated pressure P_{1R} or the second regulated pressure P_{2R} is supplied to fuel consumer 20, and (iv) influence the flow of the gaseous fuel in gaseous-fuel system 10 in other ways using valves and conduits. In the illustrated embodiment, valves 90 and 95 are fluidly connected with first supply 30 and second supply 40, respectively, and can be actuated to select whether respective first supply 30 or second supply 40 supplies the gaseous fuel at respective first and second storage pressures P_{S1} and P_{S2} to inlet 72 of first pressure regulator 70. Valves 100 and 105 are fluidly connected with first supply 30 and second supply 40, respectively, and can be actuated to select whether respective first supply 30 or second supply 40 supplies the gaseous fuel at respective first and second storage pressures P_{S1} and P_{S2} to inlet 62 of compressor 60. Valves 110 and 115 are fluidly connected with first supply 30 and second supply 40, respectively, and can be actuated to select whether respective first supply 30 or second supply 40 supplies the gaseous fuel at respective storage pressures P_{S1} and P_{S2} to inlet 82 of second pressure regulator 80. Valves 90,95 and 100,105 and 110,115 (or any other valve herein that can be automatically actuated, for example by controller 130) can be solenoid valves that are electromagnetically actuated to move a valve member (not shown) to either open or close the valve, or they can be hydraulically actuated valves that employ a pressurized hydraulic fluid to move the valve member between open and closed positions, or they can be other types of (automatically) actuatable valves. In the illustrated embodiment valves 90,95 and 100,105 and 110,115 are two-way valves; however, in other embodiments valves 90 and 95 (or valves 100 and 105, or valves 110 and 115) can be part of a three-way valve that can be actuated to select between first supply 30 or second supply 40. Controller 130 is operatively connected with valves 90,95 and 100,105 and 110,115 such that controller 130 can command each of these valves (independently and separately from each other) to either the open position or the closed position.

Check valves 35 and 45 reduce and preferably prevent back flow of the gaseous fuel into first supply 30 and second supply 40, respectively from supply-select apparatus 50. Alternatively, or in addition to check valves 35 and 45, in other embodiments other check valves can be employed in any other conduit or conduit segment to reduce and preferably prevent back flow, split conduits into smaller volumes, and/or to maintain pressure in conduits. In gaseous fuel systems backflow generally is not a condition that requires mitigation; however, in the gaseous-fuel systems herein that include more than one supply of the gaseous fuel, there may be circumstances where one supply has greater pressure than the other supply such that a condition might arise where the higher-pressure supply would cause a flow of the gaseous fuel into the lower-pressure supply. For example, second storage pressure P_{S2} of second supply 40 may be higher than first storage pressure P_{S1} of first supply 30 such that in the absence of check valves a circumstance may arise where the second supply 40 causes gaseous fuel to be returned to first supply 30 (that is, the pressure between the first supply 30 and the second supply 40 would equalize). Check valve 120 can prevent back flow towards first supply 30 or second supply 40 (although check valves 35 and 45 also perform this function) and reduces a volume downstream of compressor outlet 64 and upstream of first pressure regulator 70 that compressor 60 needs to pressurize, which can reduce the time needed to pressurize the fluid in this volume. More particularly, check valve 120 divides the conduits C5 and C6 such that conduit C6 is a smaller volume compared to a volume of conduits C5 and C6 taken together, which allows for the pressure in conduit C6 to be increased more rapidly by compressor 60. Conduit C6 (comprising conduit segments C6A, C6B, and C6C) functions in part as an accumulator to reduce pressure spikes/surges from the compressor. Alternatively, or additionally, an accumulator vessel can be employed. In some embodiments, compressor 60 is followed by an accumulator (conduit or vessel) and a check valve (for example, along conduit segment C6C). As used herein, conduit Cx, where x is a numeric character, can include two or more conduit segments Cxy, where y is an alpha character, and the conduit segments are connected at one or more nodes Nx where x is a numeric character. For example, with reference to FIG. 1 conduit C5 includes conduit segments C5A, C5B, and C5C that are fluidly connected at node N5. Conduits may not be labeled herein if they are not explicitly discussed, and all black circles in the figures herein interconnecting conduit segments are nodes and may not be labelled if they are not explicitly discussed. A conduit fluidly connecting three or more components can include different combinations of conduit segments and nodes, and these different combinations are considered substantially equivalent herein. The terms conduit and conduit segment can be used interchangeably herein.

Gaseous-fuel system 10 can include pressure sensors 32 and 42 that are employed to determine the pressure of first supply 30 and second supply 40, respectively. Pressure sensor 32 emits signals representative of first storage pressure P_{S1} that are received by controller 130 and controller 130 can be programmed to determine first storage pressure P_{S1} based on these signals. Pressure sensor 42 emits signals representative of second storage pressure P_{S2} that are received by controller 130, and controller 130 can be programmed to determine second storage pressure P_{S2} based on these signals. Pressure sensors 32 and 42 can be configured in other locations in gaseous-fuel system 10 that substantially represent storages pressures P_{S1} and P_{S2}, respectively. For example, pressure sensor 32 can be part of first supply 30 or can be configured in conduit segments C3A, C3B, C3C, or C3D; and similarly, pressure sensor 42 can be part of second supply 40 or can be configured in conduit segments C4A, C4B, C4C, or C4D. Gaseous-fuel system 10 can include pressure sensor 150 and/or pressure sensor 160 to determine the pressure of pressurized pressure P_{P} and delivery pressure P_{D}, respectively. Pressure sensor 150 emits signals representative of the pressurized pressure P_{P} of the gaseous fuel near to and at outlet 64 of compressor 60 that are received by controller 130 and controller 130 can be programmed to determine the pressurized pressure P_{P} based on these signals. Pressure sensor 160 emits signals representative of the delivery pressure P_{D} of the gaseous fuel in conduit C8 (segments identified as C8A, C8B, and C8C in FIG. 1) that delivers the gaseous fuel to fuel consumer 20 that are received by controller 130, and controller 130 can be programmed to determine the delivery pressure P_{D} based on these signals. While not expressly shown, embodiments herein can also optionally feature a temperature sensor with anyone or more pressure sensors.

Compressor 60 can fluidly receive the gaseous fuel from first supply 30 or second supply 40 through valves 100 and 105, respectively at inlet 62 such that compressor 60 can pressurize the gaseous fuel from inlet 62 to outlet 64. In this way compressor 60 can pressurize the first storage pressure P_{S1} of first supply 30 or the second storage pressure P_{S2} of second supply 40 to the pressurized pressure P_{P}. It is also possible to pressurize the gaseous fuel when both the first supply 30 and the second supply 40 are supplying gaseous fuel to compressor 60 simultaneously. A value of the pressurized pressure P_{P} provided by compressor 60 can change depending upon engine operating conditions and/or the respective storage pressures P_{S1} and P_{S2} of first supply 30 and second supply 40. Compressor 60 delivers the pressurized gaseous fuel through its outlet 64 to inlet 72 of first pressure regulator 70. Controller 130 can be operatively connected with compressor 60 to effectively turn the compressor on or off. Compressor 60 can be several types of pumps, for example compressor 60 can be a reciprocating piston pump, a diaphragm pump, or a centrifugal pump, although other types of pumps are contemplated and depending upon the application one type of pump may be more suitable. Compressor 60 can be actuated by several methods, for example the compressor can be actuated hydraulically, pneumatically, mechanically, or electromagnetically. Compressor 60 can be configured in a variety of ways, for example the compressor can be configured in terms of single acting pump, double acting pump, and quad acting pump, as well as in terms of single stage and double stage (or even more stages). When compressor 60 is hydraulically actuated, a hydraulic motor (not shown) can provide a selective hydraulic fluid flow that can actuate compressor 60, where the hydraulic motor can be a fixed displacement hydraulic pump or a variable displacement hydraulic pump. In an exemplary embodiment compressor 60 is a single stage, hydraulically actuated, reciprocating piston pump driven by a variable displacement hydraulic pump, This type of compressor allows an instantaneous mass flow of compressor 60 (that is, the compressor output) to be controlled proportional to the pressurized pressure P_{P} (that is, the compressor outlet pressure) to reduce and preferably minimize pressure fluctuations in conduit C6 in the illustrated embodiment, which is in fluid communication with inlet 72 of first pressure regulator 70. In those embodiments where compressor 60 is hydraulically actuated and driven by a hydraulic pump, controller 130 can control compressor 60 (and particularly the mass flow out of outlet 64) by modulating the hydraulic fluid flow from the hydraulic pump and can effectively turn the compressor off by reducing the hydraulic fluid flow to the compressor to zero (that is, by shutting off the hydraulic fluid flow).

First pressure regulator 70 down regulates the pressure of the gaseous fuel at its inlet 72 to the first regulated pressure P_{1R} at its outlet 74, and second pressure regulator 80 down regulates the pressure of the gaseous fuel at its inlet 82 to the second regulated pressure P_{2R} at its outlet 84. Recalling that the first regulated pressure P_{1R} is greater than the second regulated pressure P_{2R}, in this regard, first pressure regulator 70 can be considered a high-pressure pressure regulator and second pressure regulator 80 can be considered a low-pressure pressure regulator, although the terms high and low in this context are relative terms since both the first regulated pressure P_{1R} and the second regulated pressure P_{2R} can be considered high pressures in some applications. Fuel consumer 20 is fluidly connected with outlet 74 of first pressure regulator 70 and outlet 84 of second pressure regulator 80 to fluidly receive the gaseous fuel at the first regulated pressure P_{1R} and the second regulated pressure P_{2R}, respectively. In the illustrated embodiment, the fluid communication of the gaseous fuel between outlet 74 of first pressure regulator 70 and fuel consumer 20 is through valve 140 that can be commanded by controller 130 to the open position, when the fuel consumer is to receive the gaseous fuel at the first regulated pressure P_{1R}, or commanded by controller 130 to the closed position when the fuel consumer is to receive the gaseous fuel at the second regulated pressure P_{2R}. That is, second pressure regulator 80 can function like a check valve when valve 140 is in the open position such that the higher-pressure output of first pressure regulator 70 effectively closes the check-valve like second pressure regulator 80 stopping mass flow therethrough. Valve 140 can be considered part of supply-select apparatus 50 and can be similar in type of any one of valves 90,95 and 100,105 and 110,115. Valve 140 is also referred to as a delivery valve that is configured to selectively enable a flow of gaseous fuel from first pressure regulator 70 to the internal combustion engine. When the delivery valve 140 is in an open position, the first pressure regulator 70 can be configured to supply a high-pressure flow to the fuel consumer 20, and when the delivery valve 140 is in a closed position, the second pressure regulator 80 can be configured to supply a low-pressure flow to the fuel consumer 20. In other embodiments, valve 140 can be configured upstream of inlet 72 of first pressure regulator 70 in conduit C6B.

First pressure regulator 70 and second pressure regulator 80 can be the same type of pressure regulator or they can be distinct types. First pressure regulator 70 and second pressure regulator 80 can be mechanical pressure regulators that do not require actuation or control by controller 130 to regulate or not to regulate; alternatively, they can be electronically-controlled pressure regulators that are commanded by controller 130 to regulate the pressure at inlets 72, 82 to target pressures at outlets 74, 84, respectively. In further embodiments, pressure regulators 70 and 80 can be fuel-injector-type regulators commanded by controller 130 to inject a mass of gaseous fuel from conduit C6 or C7, respectively, into conduit C8, where pressure sensor 160 monitors the pressure in conduit C8 to provide the signals representative of delivery pressure P_{D} to controller 130. Note that in this circumstance, one fuel-injector-type regulator can be employed to regulate the delivery pressure P_{D} to a plurality of desired values. In other embodiments, a dual pressure regulator (not shown) that can regulate pressure to two different outlet pressures can be employed instead of first and second pressure regulators 70,80. In the embodiments employing the fuel-injector-type regulator or the dual pressure regulator, respective inlets of the fuel-injector-type regulator and the dual pressure regulator can be fluidly connected to valves 90,95 and outlet 64 of compressor 60, and valves 110,115 can be eliminated.

Controller 130 can be an engine controller when fuel consumer 20 is an internal combustion engine or a fuel system controller that communicates with the engine controller of the internal combustion engine. Controller 130 can include both hardware and software components. The hardware components can include digital and/or analog electronic components. In the embodiments herein controller 130 can include a processor and one or more memories, including one or more permanent memories, such as FLASH, EEPROM and a hard disk, and a temporary memory, such as SRAM and DRAM, for storing and executing a program. As used herein, the terms algorithm, module and step refer to an application specific integrated circuit (ASIC), an electronic circuit, a processor (shared, dedicated, or group) and memory that execute one or more software or firmware programs, a combinational logic circuit, and/or other suitable components that provide the described functionality. The algorithms, modules and steps that are performed by controller 130 are part of the controller. Double-arrowed lines adjacent controller 130, when illustrated, can represent communication channels, which can be either bidirectional or unidirectional, to the components that controller 130 either or both receives status information from and sends command information to, and these components can also have adjacent double-arrowed lines.

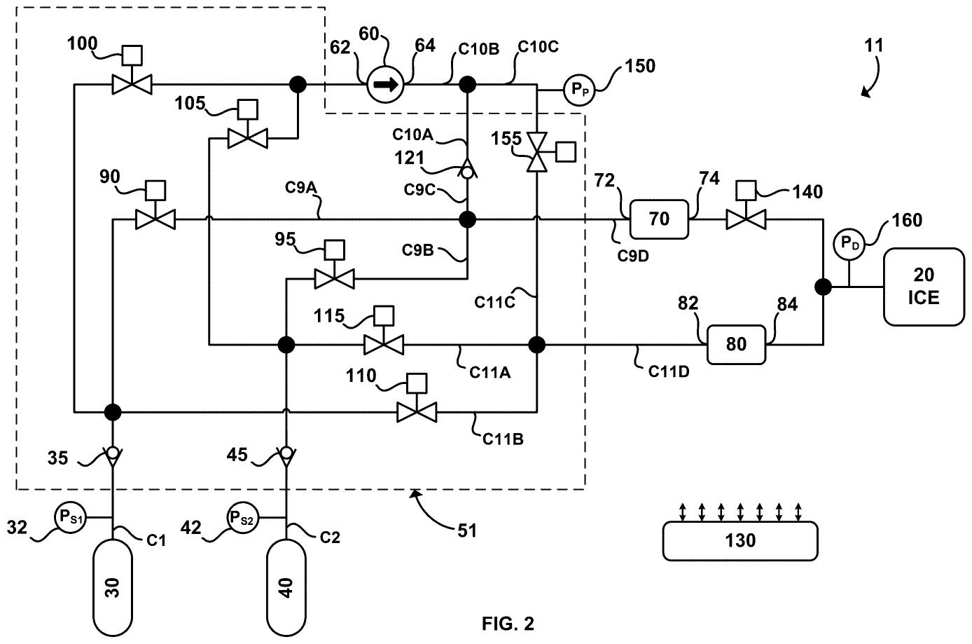

Referring now to FIG. 2, there is shown gaseous fuel system 11 according to another embodiment that is like the embodiment of FIG. 1 and like parts in this and other embodiments have like reference numerals and differences are discussed. Gaseous-fuel system 11 and supply-select apparatus 51 have substantially the same topology and architecture as gaseous-fuel system 10 and supply-select apparatus 50 (seen in FIG. 1), respectively. Check valve 121 (which replaces check valve 120 seen in FIG. 1) downstream from compressor outlet 64 can function as a pulse dampener to reduce compressor surges seen at inlet 72 of first pressure regulator 70. The gaseous fuel from first supply 30 or second supply 40 flows through check valve 121 only when compressor 60 is pressurizing the gaseous fuel (whereas the gaseous fuel that flows through check valve 120 in FIG. 1 is not pressurized by compressor 60). Pressure surges resulting from the periodic compression of the gaseous fuel by compressor 60 occur at outlet 64 and within conduit C10 (including segments C10A and C10B), and these pressure surges can be softened through check valve 121 such that pressure fluctuations within conduit C9 are reduced. A volume of conduit C9 can be reduced by locating valves 90 and 95 and check valve 121 closer to first pressure regulator 70. Although check valve 121 prevents back flow, compressor 60 itself typically does not allow for back flow therethrough. Valve 155 can be commanded by controller 130 to selectively fluidly-connect compressor outlet 64 with inlet 82 of second pressure regulator 80 such that the gaseous fuel from either first supply 30 or second supply 40 can be pressurized by compressor 60 before fluidly communicating the gaseous fuel to the second pressure regulator 80. Conduit C10 can be maintained at a higher pressure than conduit C11 (including segments C11A, C11B, C11C, and C11D) when valve 155 is in the closed position, which can reduce the amount of time it takes to pressurize conduit C10 to allow mass flow through check valve 121 in some circumstances.

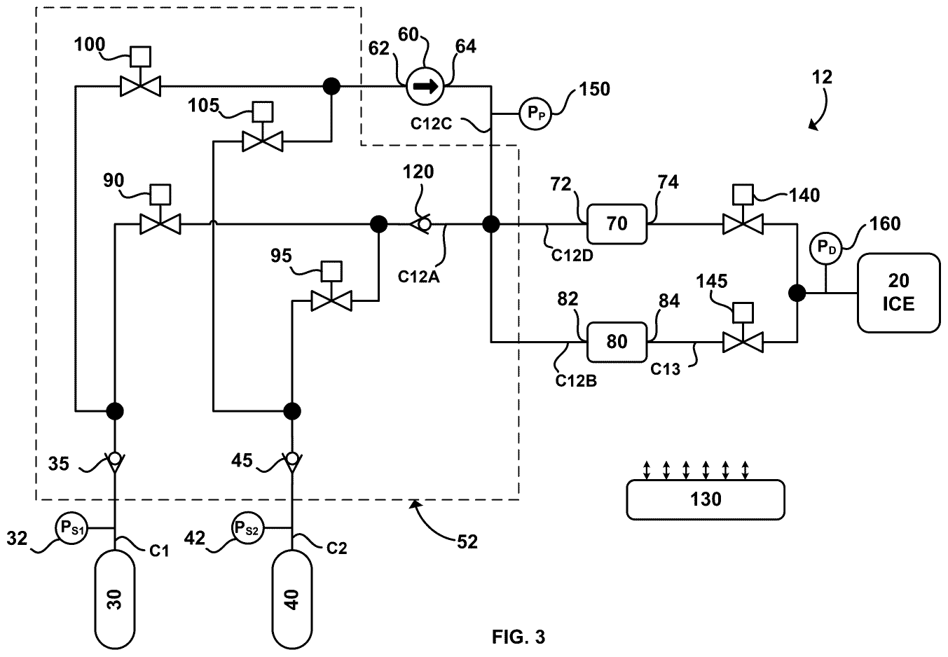

Gaseous-fuel system 12 seen in FIG. 3 according to another embodiment includes supply-select apparatus 52 that eliminates valves 110 and 115 seen in supply-select apparatus 50 of FIG. 1 by fluidly connecting inlet 82 of second pressure regulator 80 with inlet 72 of first pressure regulator 70. Valve 145 downstream from second pressure regulator 80 can be actuated by controller 130 to either an open position or a closed position such that it can be selectively isolated from fuel consumer 20. In other embodiments valve 145 is not required when second pressure regulator 80 effectively operates as a check valve (reducing and preferably preventing back flow from conduit C13 into conduit C12, shown as segments C12A, C12B, C12C, and C12D) when valve 140 is in the open position and delivery pressure P_{D} is at the first regulated pressure P_{1R} determined by first pressure regulator 70 (which is greater than the second regulated pressure P_{2R} determined by second pressure regulator 80). Alternatively, instead of valve 145 that can be actuated by controller 130, a check valve can be employed. Valve 145 can be considered part of supply-select apparatus 52, and in other embodiments valve 145 can be configured upstream of inlet 82 of second pressure regulator 80 in conduit C12B.

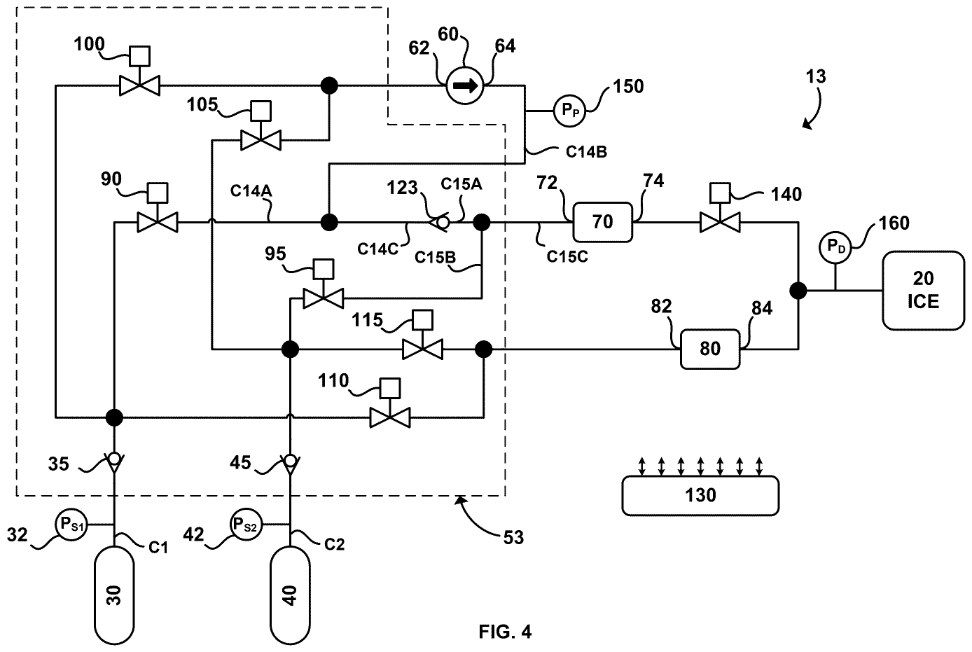

Referring now to FIG. 4, there is shown gaseous-fuel system 13 including supply-select apparatus 53 according to another embodiment. Check valve 123 reduces and preferably prevents back flow to first supply 30 through valve 90 and to compressor 60. Second supply 40 is fluidly connected to inlet 72 of first pressure regulator 70 downstream from check valve 123, whereby the gaseous fuel that flows from second supply 40 through valve 95 into inlet 72 does not flow through check valve 123. As in the previous embodiments and as will be described in more detail below, the gaseous fuel from second supply 40 can be supplied through valve 95 to first pressure regulator 70 while simultaneously the gaseous fuel from first supply 30 can be supplied to compressor 60 and compressed thereby. In the illustrated embodiment of FIG. 4, the gaseous fuel from outlet 64 of compressor 60 will not be supplied to first pressure regulator 70 due to check valve 123 until the pressure of the gaseous fuel in conduit C14 is greater than the pressure of the gaseous fuel in conduit C15 (shown as segments C15A, C15B, and C15C), which is substantially the second storage pressure P_{S2} when valve 95 is in the open position fluidly connecting second supply 40 to conduit C15 and first pressure regulator 70.

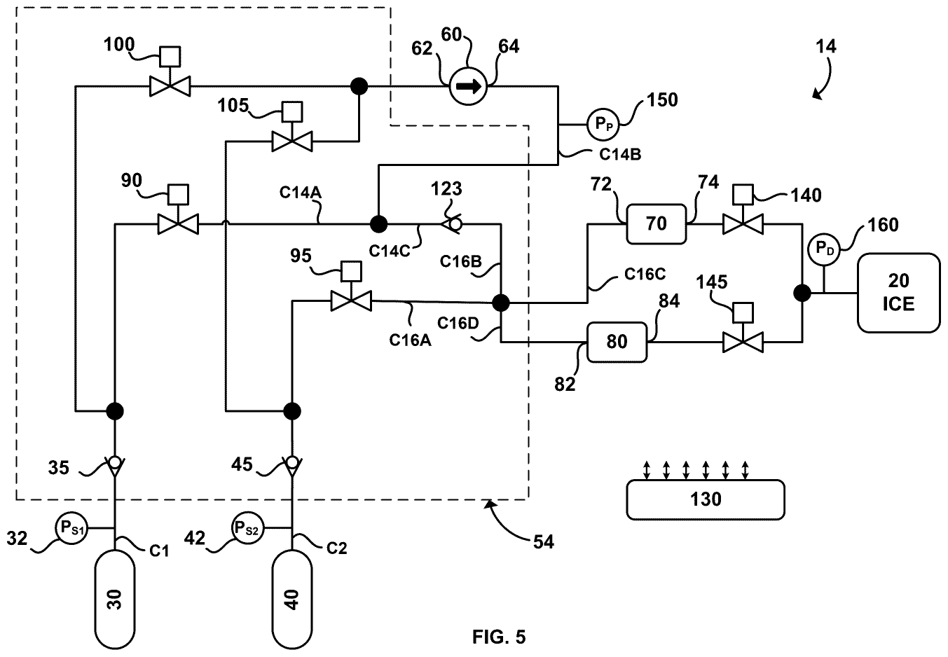

With reference to FIG. 5, there is shown gaseous-fuel system 14 and supply-select apparatus 54 according to another embodiment that is like gaseous fuel system 13 seen in FIG. 4. Inlet 82 of second pressure regulator 80 is fluidly connected with inlet 72 of first pressure regulator 70, whereby valves 110 and 115 seen in gaseous fuel system 14 of FIG. 4 have been eliminated (like gaseous-fuel system 12 seen in FIG. 3). More particularly, conduit C16 (shown as segments C16A, C16B, C16C, and C16D) fluidly interconnects check valve 123, valve 95, first pressure regulator 70, and second pressure regulator 80.

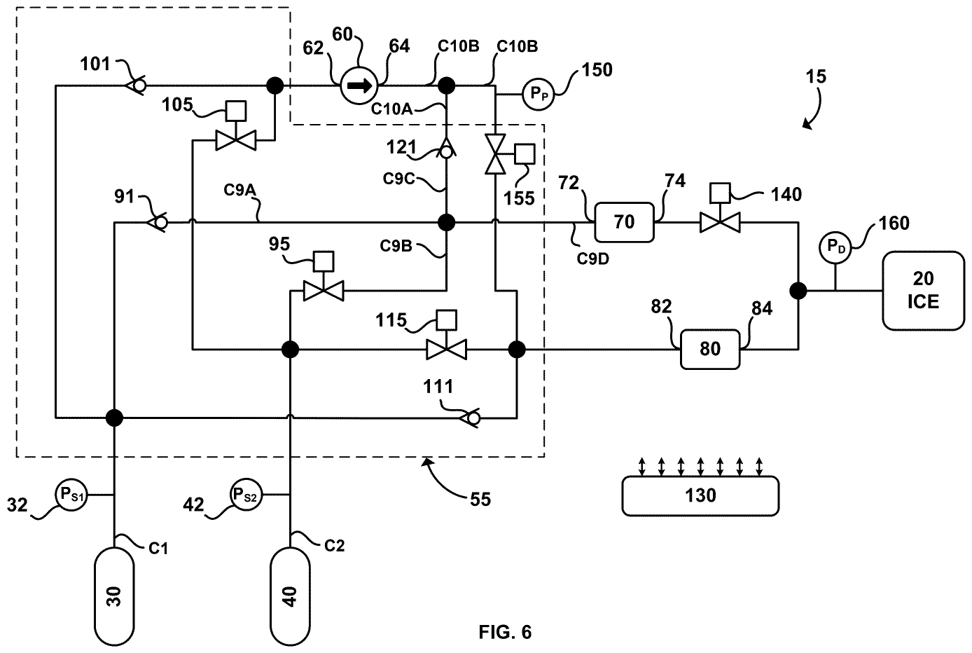

Referring now to FIG. 6, there is shown gaseous-fuel system 15 and supply-select apparatus 55 according to another embodiment that is like gaseous fuel system 13 seen in FIG. 2. Check valves 35 and 45 (seen in FIG. 2) have been eliminated, solenoid valve 90 has been replaced by check valve 91, solenoid valve 100 has been replaced by check valve 101, and solenoid valve 110 has been replaced by check valve 111. In an exemplary embodiment, first storage pressure P_{S1} of first supply 30 is typically lower than second storage pressure P_{S2} of second supply 40 during operation (although initially they can be filled to the same pressure) such that check valve 91 is closed when valve 95 is in the open position, valve 101 is closed when valve 105 is in the open position, and valve 111 is closed when valve 115 is in the open position, whereby backflow of the gaseous fuel into first supply 30 is reduced and preferably prevented.

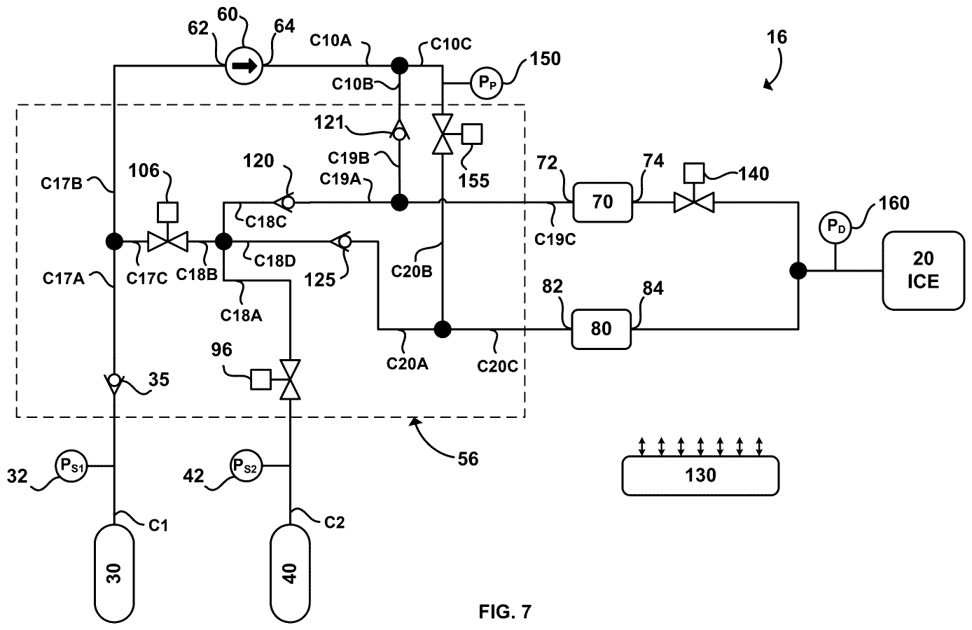

With reference now to FIG. 7, there is shown gaseous-fuel system 16 and supply-select apparatus 56 according to another embodiment. First supply 30 is in selective fluid communication with first pressure regulator 70 through check valves 35 and 120 and valve 106; first supply 30 is in selective fluid communication with second pressure regulator 80 through check valves 35 and 125 and valve 106; and first supply 30 is in fluid communication with compressor 60 through valve 35. Second supply 40 is in selective fluid communication with first pressure regulator 70 through valve 96 and check valve 120; second supply 40 is in selective fluid communication with second pressure regulator 80 through valve 96 and check valve 125; and second supply 40 is in selective fluid communication with compressor 60 through valves 96 and 106. Valves 96 and 106 are automatically actuatable valves, particularly by controller 130, and accordingly are operatively connected with the controller. In the illustrated embodiment valves 96 and 106 can be solenoid-type valves. When valves 96 and 106 are all in the open position, check valve 35 prevents backflow of the gaseous fuel into first supply 30 when second storage pressure P_{S2} of second supply 40 is greater than first storage pressure P_{S1} of first supply 30. In other embodiments additional check valves can be included; for example, a check valve can be included between second supply 40 and valve 96 to prevent backflow into second supply 40 when valves 96 and 106 are in the open position and first storage pressure P_{S1} is greater than second storage pressure P_{S2}. All the gaseous fuel flow from first supply 30 or second supply 40 (without pressurization from compressor 60) flowing through first pressure regulator 70 also flows through check valve 120. Similarly, all gaseous fuel flow from first supply 30 or second supply 40 (without pressurization from compressor 60) flowing through second pressure regulator 80 also flows through check valve 125. Check valves 120 and 125 permit compressor 60 to pressurize conduits C19 (shown as segments C19A, C19B, and C19C) and C20 (shown as segments C20A, C20B, and C20C) to higher pressures than that present in conduits C18 (shown as segments C18A, C18B, C18C, and C18D) and/or C17 (shown as segments C17A, C17B, and C17C). Valve 106 when in the closed position allows for fluid communication of the gaseous fuel from first supply 30 through conduit C17 towards compressor 60 while simultaneously allowing for fluid communication of the gaseous fuel from second supply 40 through conduit C18 towards check valves 120 and 125; and when compressor 60 is on and pressurizing conduit C10, there will be gaseous fuel flow from conduit C10 through first pressure regulator 70 when the pressurized pressure P_{P} is greater than the second storage pressure P_{S2} and when valve 140 is in the open position; alternatively, there will be gaseous fuel flow from conduit C10 through second pressure regulator 80 when the pressurized pressure P_{P} is greater than the second storage pressure P_{S2} and when valve 155 is in the open position. Valve 155 allows for pressurized pressure P_{P} in conduit C10 to remain higher than the pressure of the gaseous fuel in conduit C20, such as when there is fluid communication of the gaseous fuel through second pressure regulator 80 from either first or second supply 30 and 40, respectively, when the first or second storage pressures P_{S1} and P_{S2} are less than the pressurized pressure P_{P}. A check valve can be included immediately downstream from outlet 84 of second pressure regulator 80 to reduce and preferably prevent backflow into or a high pressure condition at outlet 84 of second pressure regulator 80 when valve 140 is in the open position, particularly when second pressure regulator 80 leaks from outlet 84 to inlet 82 when the outlet pressure is greater than the inlet pressure.

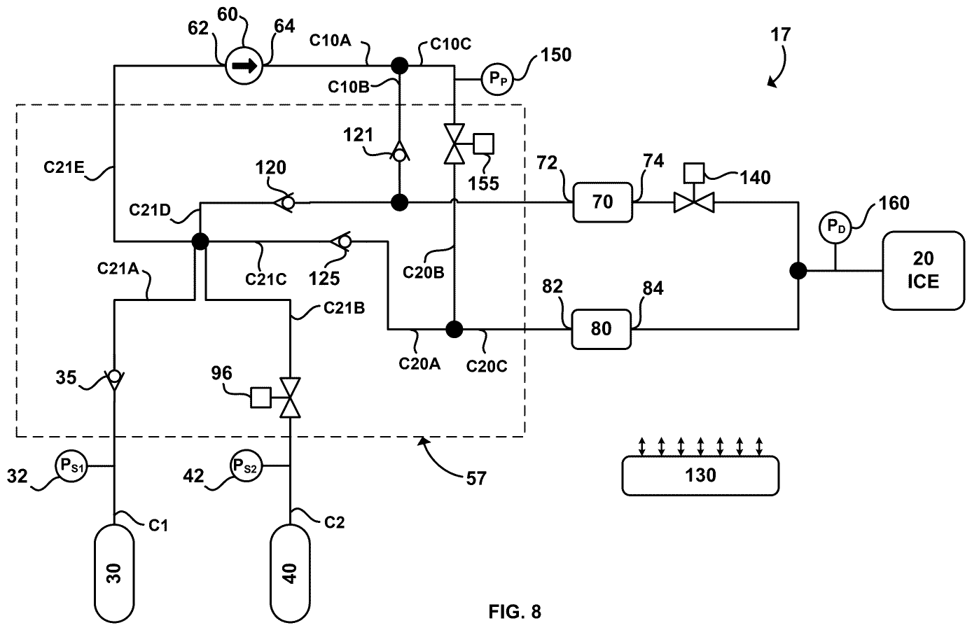

Referring now to FIG. 8, there is shown gaseous-fuel system 17 and supply-select apparatus 57 according to another embodiment. The gaseous fuel from first supply 30 or second supply 40 can be fluidly communicated through conduit C21 (shown as segments C21A, C21B, C21C, C21D, and C21E) to inlet 62 of compressor 60, inlet 72 of first pressure regulator 70, and inlet 82 of second pressure regulator 80 (that is, a common conduit delivers the gaseous fuel from the first and second supplies to these components). Gaseous-fuel system 17 is like gaseous-fuel system 16 where valve 106 and conduits C17 and C18 seen in FIG. 7 have been replaced with conduit C21 seen in FIG. 8. Accordingly, it is not possible to fluidly communicate the gaseous fuel from first supply 30 only through compressor 60 to pressurize the gaseous fuel while simultaneously fluidly communicating the gaseous fuel from second supply 40 only through first or second pressure regulators 70 and 80, respectively. In other embodiments, valve 155 can be removed from gaseous-fuel systems 16 and 17 if there is no need to pressurize the gaseous fuel for low-pressure flow through second pressure regulator 80. Alternatively, valve 155 can be replaced by a check valve; however, the check valve cannot maintain conduit C10 at a higher pressure than conduit C20 in this circumstance.

Returning to the discussion of first supply 30 and second supply 40, various storage volume ratios between the storage volume of first supply 30 over the storage volume of second supply 40 can be employed. Additionally, various configurations of gas cylinders can be employed to form first and second supplies 30 and 40, respectively. With reference to FIG. 9, there is shown gas cylinders S1, S2, S3, S4, S5, and S6 that can be fluidly connected with conduits C1 or C2 (seen in FIGS. 1 to 8) in a variety of configurations. Gas cylinders S1 through S6 have identical volumes, although in other embodiments gas cylinders that comprise different volumes can also be employed to create the desired storage volumes of first supply 30 and/or second supply 40. In configuration 170, gas cylinders S1, S2, and S3 represented by line 180 are fluidly connected with conduit C1 and gas cylinders S4, S5, and S6 represented by line 190 are fluidly connected with conduit C2. The storage volume ratio between first supply 30 over second supply 40 is 3:3 in configuration 170. In configuration 171, gas cylinders S1, S2, S3, and S4 represented by line 181 are fluidly connected with conduit C1 and gas cylinders S5 and S6 represented by line 191 are fluidly connected with conduit C2, and the storage volume ratio is 4:2 in configuration 171. In configuration 172, gas cylinders S1, S2, S3, S4, and S5 represented by line 182 are fluidly connected with conduit C1 and gas cylinder S6 represented by line 192 is fluidly connected with conduit C2, and the storage volume ratio is 5:1 in configuration 172. In configuration 173, gas cylinders S1, S2, and S3 represented by line 183 are fluidly connected with conduit C1 and gas cylinders S4 and S5 represented by line 193 are fluidly connected with conduit C2 (whereby gas cylinder S6 is not employed and can be removed), and the storage volume ratio is 3:2 in configuration 173. In configuration 174, gas cylinders S1 and S2 represented by line 184 are fluidly connected with conduit C1 and gas cylinders S3, S4, and S5 represented by line 194 are fluidly connected with conduit C2 (whereby gas cylinder S6 is not employed and can be removed), and the storage volume ratio is 2:3 in configuration 174. In configuration 175, gas cylinder S1 represented by line 185 is fluidly connected with conduit C1 and gas cylinder S2 represented by line 195 is fluidly connected with conduit C2 (whereby gas cylinders S3, S4, S5, and S6 are not employed and can be removed), and the storage volume ratio is 1:1 in configuration 175. The storage volume ratios 3:3 and 1:1 are essentially the same ratios that are arrived at through different numbers of gas cylinders, where the storage volume ratio 3:3 further represents that three gas cylinders are employed in each of the first supply 30 and the second supply 40, whereas the storage volume ratio 1:1 further represents that only one gas cylinder is employed in each of the first and second supply 30 and 40, respectively. In other embodiments, other storage volume ratios can be employed, and some non-limiting examples include 3:1, 4:1, 1:2, 1:3, 1:4, 1:5. One or more gas cylinders can be selectively fluidly connected with conduit C1 or C2 in some embodiments. Referring to FIG. 10, gas cylinder S3 is selectively fluidly connected with conduit C1 or conduit C2 by way of valve 92. In the illustrated embodiment, valve 92 is a three-way solenoid valve; however, in other embodiments valve 92 can be two two-way valves. Controller 130 can command valve 92 between a first open position fluidly connecting conduit C1 with gas cylinder S3, a second open position fluidly connecting conduit C2 with gas cylinder S3, and a closed position fluidly isolating conduits C1 and C2 from gas cylinder S3. In this regard, configuration 173 is enabled when valve 92 is in the first open position, configuration 174 is enabled when valve 92 is the second open position, and configuration 176 is enabled when valve 92 is the closed position. In configuration 176, gas cylinders S1 and S2 represented by line 186 are fluidly connected with conduit C1 and gas cylinders S4 and S5 represented by line 196 are fluidly connected with conduit C2, and the storage volume ratio is 2:2 in configuration 176. In other embodiments each gas cylinder S1 to S5 (and even more gas cylinders in further embodiments) can include a respective three-way valve, and each three-way valve can fluidly connect the respective gas cylinder with conduit C1 or C2 accordingly, whereby granular control over the storage volume ratio is improved. Rainfall strategies can be employed where one or more banks are assigned to first supply 30, initially, and when these tanks are depleted or empty other full (or fuller) tanks can then be assigned to first supply 30, and similarly with second supply 40. In still further embodiments any number of gas cylinders out of a plurality of gas cylinders can each have a three-way valve connecting each to conduits C1 and C2. A variety of factors can influence what storage volume ratio between first supply 30 and second supply 40 to employ and how many gas cylinders to employ in a particular application. The size of compressor 60 and, when the fuel consumer 20 is an internal combustion engine of a vehicle, a duty cycle of the vehicle are two factors that influence the storage volume ratio between first supply 30 and second supply 40. The duty cycle of the vehicle can be defined as vehicle speed or fuel consumption versus time. In some embodiments, there can be a preference to employ first supply 30 over second supply 40 when there is a desire to preserve the second storage pressure P_{S2} in second supply 40, and these factors can influence the storage volume of first supply 30 to be greater than the storage volume in second supply 40. However, when the second storage pressure PS2 of second supply 40 drops below a minimum pressure required by the internal combustion engine to operate, then it will be unlikely that the first storage pressure PS1 can reach that minimum pressure. The duty cycle of the vehicle is important as it dictates the gaseous-fuel consumption and particularly the timing of high consumption events. The system can be considered ‘empty’ when it can no longer maintain the pressure needed by the engine (without power deration). When the vehicle duty cycle has more high consumption events, then it will hit this empty state earlier. A system with a larger compressor is typically less sensitive to high consumption events, and when the compressor is large to match the high consumption, then the system is less sensitive to the high consumption events. The timing of the high consumption events can be significant, for example it is these high consumption events when the first and second supplies 30 and 40 are near empty and cannot flow as much that cause the system to be ‘empty’. When a first phase of the vehicle duty cycle is mostly uphill and then a second phase is mostly downhill, the range of the vehicle will generally be higher than if the same route is done in reverse order (mostly downhill then mostly uphill) even though the average fuel economy is the same.

In any of the embodiments, when the storage volume ratio can be adjusted, the storage volume ratio can be optionally configured by an operator of the vehicle based on the duty cycle that will be encountered on a particular day or on a particular trip, for example by the operator entering a planned (e.g. geographical location based) route for the vehicle directly to controller 130 which can be programmed to then determine an optimum configuration. Alternatively, or in addition to the storage volume ratio being configured by an operator, the storage volume ratio can be configured based on a predictive mode of operation. For example, a predictive mode of operation can be based on any one or more of a learned operator use pattern for a particular vehicle or vehicle type; a learned operator use pattern for one or more similar vehicles based on previous duty cycles or previous trips; a geographical location based input that could indicate for example imminent refueling and/or imminent high load requirements in a route in order to provide a determined optimum configuration of the storage volume ratio to controller 130. An optimum configuration can also optionally be determined by a separate vehicle communications, analysis and operations system which typically includes system hardware, firmware, and software components and how they interface within the system. An exemplary vehicle communications, analysis and operations system is described in U.S. Pat. No. 9,014,888, which is incorporated herein by reference. As described in U.S. Pat. No. 9,014,888, the vehicle operation system, can include the vehicle equipped with a separate programmable vehicle data system which communicates with controller 130 an optimum fuel storage volume ratio between the storage volume of first supply 30 over the storage volume of second supply 40 based on a predetermined duty cycle, a learned duty cycle or even imminent high load requirements in the route. An onboard vehicle data system can optionally be partially or entirely included in controller 130 or housed separately and configured to transmit and receive data from controller 130. Similar to controller 130, a separate vehicle data system can contain a processor (CPU) and a ROM and a RAM coupled to the CPU. The ROM has multiple inputs and outputs and contains firmware which provides static information and instructions to the CPU. The RAM contains software that performs the computations necessary for calculating routes, reporting and analyzing of vehicle specific data including the type(s) of fuel on-board and fuel storage arrangement and fuel supply architecture, managing inputs and outputs and can display information to an operator. The vehicle data system also includes a data storage device, coupled to the CPU, for storing user inputted, real-time, and historical data, and a transceiver, coupled to the CPU, for transmitting and receiving data over a wired or wireless communications network. The inputs and outputs can be any known in the art that allow the vehicle data system to receive and communicate logical data with for instance a user interface; such as but not limited to a display, audio system, keyboard; USB, flash, Bluetooth, near field communication or other data transferable ports and mediums; and factory or 3rd party installed vehicle systems. The vehicle can optionally be equipped with a GPS (or other navigational system), operational sensors and environmental sensors. The vehicle data system can also be configured to communicate with the GPS, the operational sensors, such as accelerometers and optical spatial sensors, and the environmental sensors such as CO, NOx, temperature, noise (dB) and humidity sensors, as well as the vehicle's fuel architecture and vehicle operation system. The RAM of the vehicle data system contains system software for determining the most efficient route or travel plan based on a vehicle's real-time data, a vehicle's centric data collection, and assigned use patterns specific to the vehicle, an operator and/or a geospatial region. The system software of the RAM may include a data management and processing system, which includes data processing modules and one or more databases used within the vehicle operation system. The processing modules can be separate software modules but are not separate processor/memory systems. Some of these modules are on-board and some are off-board vehicles; and some of these modules can be either off-board or on-board.

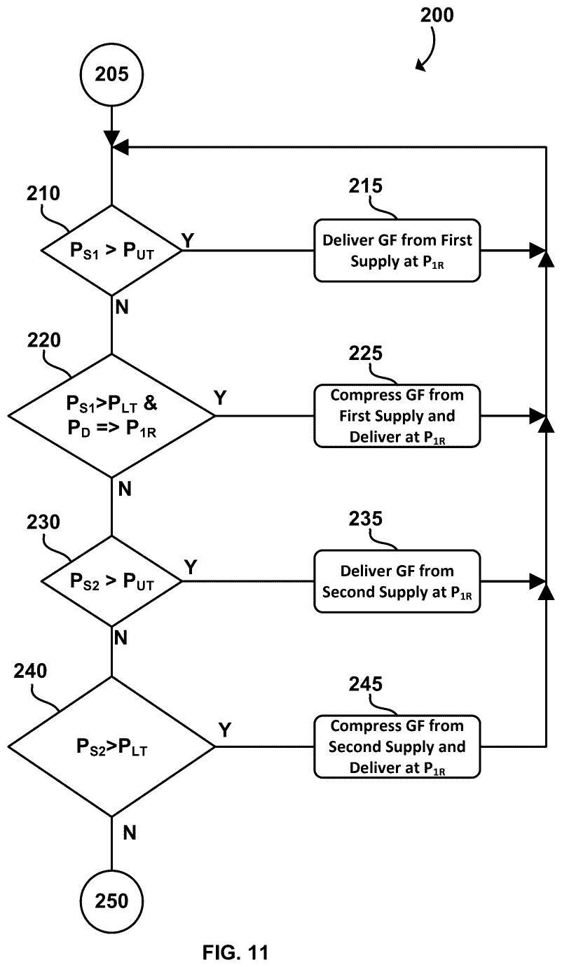

Gaseous-fuel systems 10, 11, 12, 13, 14, 15, 16 and 17 (10 to 17 hereinafter) can be operated in a diversity of ways. Referring to FIG. 11, algorithm 200 illustrates one such technique of operating gaseous-fuel systems 10 to 17, which begins in step 205 when fuel consumer 20 is ready to receive the gaseous fuel, such as when an internal combustion engine is started (note that the details of starting the internal combustion engine are not disclosed herein, and when step 205 is exited the internal combustion engine has started and is operating). Algorithm 200 can be programmed into controller 130 whereby the controller performs the various steps in the algorithm. In the illustrated embodiment, algorithm 200 represents a simplified mode of operation of gaseous-fuel systems 10 to 17 that employs only first pressure regulator 70, whereby second pressure regulator 80 and associated valves can simply not be used or can be omitted.

In step 210 the conditions that enable a high-pressure flow without compression from first supply 30 are assessed. As used herein, high-pressure flow refers to gaseous fuel flow through first pressure regulator 70 and low-pressure flow refers to gaseous fuel flow through second pressure regulator 80, where high pressure and low pressure are relative terms with respect to each other, since the actual pressure of the high-pressure flow and the low-pressure flow can be considered a low pressure and a high pressure, respectively, in some embodiments; the term “high-pressure flow without compression” refers to a flow of gaseous fuel from first supply 30 and/or second supply 40 through first pressure regulator 70 without being pressurized by compressor 60; and the term “low-pressure flow without compression” refers to a flow of gaseous fuel from first supply 30 and/or second supply 40 through second pressure regulator 80 without being pressurized by compressor 60; the term “high-pressure flow with compression” refers to a flow of gaseous fuel from first supply 30 and/or second supply 40 through first pressure regulator 70 after being pressurized by compressor 60; and the term “low-pressure flow with compression” refers to a flow of gaseous fuel from first supply 30 and/or second supply 40 through second pressure regulator 80 after being pressurized by compressor 60. Compressor 60 provides supplemental compression of the gaseous fuel that is stored as a compressed gas in first supply 30 and second supply 40. Algorithm 200 determines whether the first storage pressure P_{S1} in first supply 30 is above an upper threshold pressure P_{UT}, such that when this condition is true (Y) control is transferred to step 215 where a first stage of operation is entered, otherwise control is transferred to step 220. The upper threshold pressure P_{UT} is a lower limit on the pressure of the gaseous fuel supplied to inlet 72 of first pressure regulator 70 such that the first pressure regulator can regulate the delivery pressure P_{D} at the first regulated pressure P_{1R} whereby the internal combustion engine can operate at least up to and including a maximum rated power. The maximum rated power is the largest power at which the internal combustion engine is specified to operate. It is understood by those familiar with the technology that a margin can be included in the upper threshold pressure P_{UT}. When step 210 is true, the gaseous fuel can be supplied directly from first supply 30 to fuel consumer 20 (seen in FIGS. 1 to 8) without requiring pressurization from compressor 60. An effective maximum power of the internal combustion engine could be derated if inlet 72 of first pressure regulator 70 is supplied with the gaseous fuel having a pressure at or below the upper threshold pressure P_{UT} (and in the event there is a margin at or below the upper threshold pressure P_{UT} minus the margin). In step 215, controller 130 actuates respective supply-select apparatuses 50, 51, 52, 53, 54, 55, 56, and 57 (50 to 57 hereinafter) such that the gaseous fuel from first supply 30 is directly supplied to first pressure regulator 70 (without pressurization from compressor 60) whereby the delivery pressure P_{D} of the gaseous fuel supplied to fuel consumer 20 is the first regulated pressure P_{1R}. More particularly, valves 90 and 140 are actuated to the open position in FIGS. 1 to 5 while the other automatically actuatable valves therein are in the closed position; valve 140 is actuated to the open position in FIG. 6 while the other automatically actuatable valves therein are in the closed position; valves 106 and 140 are actuated to the open position in FIG. 7 while the other automatically actuatable valves therein are in the closed position; valve 140 is actuated to the open position in FIG. 8 while the other automatically actuatable valves therein are in the closed position; and compressor 60 is turned off in the stage defined by step 215.

Turning now to step 220, the conditions that enable a high-pressure flow with compression from first supply 30 through compressor 60 are assessed. As used herein, the term high-pressure flow with compression refers to gaseous fuel from either first supply 30 or second supply 40 being first compressed by compressor 60 and then fluidly communicated through first pressure regulator 70. Algorithm 200 determines whether the gaseous fuel from first supply 30 should be pressurized before supplying the gaseous fuel to first pressure regulator 70. More particularly, step 220 determines whether the first storage pressure P_{S1} in first supply 30 is greater than a lower threshold pressure P_{LT} and whether the delivery pressure P_{D} is equal to or greater than the first regulated pressure P_{1R} such that when these conditions are true control is transferred to step 225 where a second stage of operation is entered, otherwise control is transferred to step 230. Additionally, it is understood that the first storage pressure P_{S1} is less than or equal to the upper threshold pressure P_{UT} for algorithm 200 to enter step 220, and in this regard, this condition can be considered an implicit requirement for step 220. The lower threshold pressure P_{LT} is determined primarily by a compression ratio of compressor 60; and in an exemplary embodiment can be determined by dividing the first regulated pressure P_{1R} by the compression ratio of compressor 60. For example, when the compression ratio is five (5) and the first regulated pressure P_{1R} is equal to 350 bar the lower threshold pressure P_{LT} is substantially 70 bar (350/5). A margin to factor in a pressure drop across first pressure regulator 70 can be added to the first regulated pressure P_{1R} when calculating the lower threshold pressure P_{LT}, for example in other embodiments the lower threshold pressure P_{LT} can be equal to the upper threshold pressure P_{UT} divided by the compression ratio, such as when the upper threshold pressure P_{UT} equals 360 bar. In some embodiments, first pressure regulator 70 may not be able to regulate the delivery pressure P_{D} to the first regulated pressure P_{1R} for one or more fuel demands of fuel consumer 20 as the first storage pressure P_{S1} decreases and approaches the lower threshold pressure P_{LT}. This can happen when a mass flow rate of compressor 60 at one or more inlet pressures near to the lower threshold pressure P_{LT} is less than a mass flow rate of the gaseous fuel demanded by fuel consumer 20 such that compressor 60 and thereby first pressure regulator 70 cannot provide the demanded mass flow rate of the gaseous fuel whereby the delivery pressure P_{D} decreases below the first regulated pressure P_{1R}. The inlet pressure of compressor 60 is the pressure of the gaseous fuel at inlet 62. In an exemplary embodiment, when the internal combustion engine of fuel consumer 20 is in a heavy-duty trucking vehicle, compressor 60 can be selected to provide between 35% and 45% of the mass flow of fuel demanded by fuel consumer 20 when the internal combustion engine is operating at maximum rated power and the inlet pressure of the compressor is at the lower threshold pressure P_{LT}. The mass flow rate of compressor 60 can be related to the size of the compressor (and particularly a size of a compression chamber of the compressor) where all else remaining the same a compressor with a larger compression chamber (by volume) has a greater mass flow rate. Additionally, the (average) mass flow rate of compressor 60 can be related to a duty cycle of the compressor where all else remaining the same a compressor with a greater duty cycle has a greater (average) mass flow rate. The duty cycle of the compressor is the percentage of time the compressor can be operational for a total cycle time (where a compressor having a 75% duty cycle and a total cycle time of one hour the compressor can only be operated for 45 minutes and must rest for 15 minutes). The internal combustion engine can operate at and below a lower-pressure-threshold power PWR_{LPT}, when the inlet pressure of compressor 60 is substantially at the lower threshold pressure P_{LT}. A value of the lower-pressure-threshold power PWR_{LPT} is a function of the mass flow rate of compressor 60 (which in turn can be a function of the size of the compressor) and the value can be as high as the maximum rated power of the internal combustion engine (when the compressor mass flow rate can match the demanded mass flow rate of fuel consumer 20 for operation at the maximum rated power) or below the maximum rated power in which case the lower threshold power PWR_{LPT} is a derated power. Advantages of having a smaller compressor are reduced cost and weight, reduced parasitic losses of operating the compressor, and more space available for storing fuel in space constrained applications. When the fuel consumer 20 is an internal combustion engine, compressor 60 can be powered by the energy derived from combusting the gaseous fuel from first and second supplies 30 and 40; such that whenever compressor 60 is operated, the fuel economy decreases since a portion of the energy derived from combusting the gaseous fuel powers the compressor. Typically, it takes more energy to power a larger sized compressor compared to a smaller sized compressor. On the other hand, a larger sized compressor can typically provide greater gaseous-fuel mass flow at lower storage pressures compared to a smaller sized compressor, whereby the internal combustion engine can operate at maximum rated power down to lower storage pressures in first and second supplies 30 and 40 when a larger compressor is employed. For each application there is a tradeoff between these competing demands whereby the compressor is neither too large nor too small. In exemplary embodiments, the lower-pressure-threshold power PWR_{LPT} can be 25%, 50%, or 75% of the maximum rated power of the internal combustion engine. Returning to step 225, controller 130 actuates respective supply-select apparatuses 50 to 57 such that the gaseous fuel from first supply 30 is supplied to inlet 62 of compressor 60 and compressor 60 is turned on to pressurize the gaseous fuel, and the gaseous fuel from outlet 64 of the compressor is delivered to first pressure regulator 70 whereby the delivery pressure P_{D} of the gaseous fuel supplied to fuel consumer 20 (seen in FIGS. 1 to 8) is the first regulated pressure P_{1R}. More particularly, valves 100 and 140 are actuated to the open position in FIGS. 1 to 5 while the other automatically actuatable valves therein are in the closed position; valve 140 is actuated to the open position in FIGS. 6 to 8 while the other valves therein are in the closed position; and compressor 60 is turned on in the stage defined by step 225. The assessment made in step 220 in determining whether the delivery pressure P_{D} is equal to or greater than the first regulated pressure P_{1R} catches the circumstance of the compressor failing to keep up with the mass flow demand of fuel consumer 20 whereby when this condition is not met control is transferred to step 230. It is understood by those familiar with the technology that a margin can be included in the monitoring of the delivery pressure P_{D} whereby the delivery pressure P_{D} can be compared to the first regulated pressure P_{1R} minus a margin.

When algorithm 200 has reached step 230, the first supply 30 is not capable of supplying the gaseous fuel to fuel consumer 20 such that the delivery pressure P_{D} can be maintained at the first regulated pressure P_{1R} and the algorithm turns to the second supply 40 to determine whether and how it can supply the gaseous fuel to the fuel consumer 20. In step 230 the conditions that enable a high-pressure flow from second supply 40 without compression are assessed. More particularly, algorithm 200 determines whether the second storage pressure P_{S2} in second supply 40 is greater than the upper threshold pressure P_{UT} such that when this condition is true control is transferred to step 235 where a third stage of operation is entered, otherwise control is transferred to step 240. In step 235, controller 130 actuates respective supply-select apparatuses 50 to 57 such that the gaseous fuel from second supply 40 is directly supplied to first pressure regulator 70 (without being pressurized by compressor 60) whereby the delivery pressure P_{D} of the gaseous fuel supplied to fuel consumer 20 (seen in FIGS. 1 to 6) is the first regulated pressure P_{1R}. More particularly, valves 95 and 140 are actuated to the open position in FIGS. 1 to 6 while the other automatically actuatable valves therein are in the closed position; valves 96 and 140 are actuated to the open position in FIGS. 7 and 8 while the other automatically actuatable valves therein are in the closed position; and compressor 60 is commanded off by controller 130 in the stage defined by step 235.

It is noteworthy that when the fuel consumer 20 is being supplied with the gaseous fuel from first supply 30 pressurized through compressor 60 according to the stage of operation defined by step 225, the internal combustion engine may begin to be operated above the lower-pressure-threshold power PWR_{LPT} such that the mass flow provided by compressor 60 is less than the demanded mass flow by fuel consumer 20 whereby the delivery pressure P_{D} drops below the first regulated pressure P_{1R} even though the first storage pressure P_{S1} is greater than the lower threshold pressure P_{LT}. In this circumstance, algorithm 200 will switch to supplying fuel consumer 20 from second supply 40 (providing that second storage pressure P_{S2} is greater than the upper threshold pressure P_{UT}) according to the third stage of operation defined by step 235 while the internal combustion engine is operated above the lower-pressure-threshold power PWR_{LPT}, and when the internal combustion engine begins operating below the lower-pressure-threshold power PWR_{LPT} such that the delivery pressure P_{D} is equal to the first regulated pressure P_{1R} and the first storage pressure P_{S1} is greater than the lower threshold pressure P_{LT}, algorithm 200 will switch back to supplying fuel consumer 20 with the gaseous fuel from first supply 30 pressurized by compressor 60, according to the stage of operation defined by step 225. That is, algorithm 200 can jump around by operating in the stage of operation according to step 225, then step 235, and then back again to step 225. Additionally, as will be described in more detail below, in some embodiments, compressor 60 can be employed to pressurize the gaseous fuel from first supply 30 while the second supply 40 is providing a high-pressure flow through first pressure regulator 70 during step 235, whereby gaseous fuel from first supply 30 can be combined in with the gaseous fuel from second supply 40 in the high-pressure flow.

Algorithm 200 proceeds to step 240 when the second supply 40 can no longer directly supply the gaseous fuel above the upper threshold pressure P_{UT} to first pressure regulator 70 such that the first pressure regulator can regulate the delivery pressure P_{D} at the first regulated pressure P_{1R} to fuel consumer 20. In step 240, the conditions that enable a high-pressure flow from second supply 40 through compressor 60 are assessed. More particularly, algorithm 200 determines whether the second storage pressure P_{S2} in second supply 40 is greater than the lower threshold pressure P_{LT} such that when this condition is true (Y) control is transferred to step 245 where a fourth stage of operation is entered, otherwise control is transferred to step 250. In step 245, controller 130 actuates respective supply-select apparatuses 50 to 57 such that the gaseous fuel from second supply 40 is supplied to inlet 62 of compressor 60 and compressor 60 is turned on to pressurize the gaseous fuel, and the gaseous fuel from outlet 64 of the compressor is delivered to first pressure regulator 70 whereby the delivery pressure P_{D} of the gaseous fuel supplied to fuel consumer 20 (seen in FIGS. 1 to 8) is the first regulated pressure P_{1R}. More particularly, valves 105 and 140 are actuated to the open position in FIGS. 1 to 6 while the other automatically actuatable valves therein are in the closed position; valves 96, 106, and 140 are actuated to the open position in FIG. 7, while the other automatically actuatable valves therein are in the closed position; valves 96 and 140 are actuated to the open position in FIG. 7 while the other automatically actuatable valves therein are in the closed position; and compressor 60 is turned on in the stage defined by step 245. It is noteworthy that in step 245 the second storage pressure P_{S2} may be low enough (yet above the lower threshold pressure P_{LT}) and the fuel demand from fuel consumer 20 may be high enough (the engine operating above the lower-pressure-threshold power PWR_{LPT}) such that the delivery pressure P_{D} cannot be maintained at the first regulated pressure (P_{1R}), and in this circumstance the algorithm can automatically derate the effective maximum power of the internal combustion engine such that the delivery pressure P_{D} is maintained at the first regulated pressure P_{1R}. This can occur when an undersized compressor is purposively employed.

Algorithm 200 enters step 250 when both the first storage pressure P_{S1} and the second storage pressure P_{S2} are equal to or below the lower threshold pressure P_{LT}. In this stage of operation fuel consumer 20 cannot be operated at the maximum rated power and cannot be operated at or above the lower-pressure-threshold power PWR_{LPT}. Preferably before this circumstance occurs first supply 30 and second supply 40 are refilled with the gaseous fuel (for example, an operator of a vehicle driven by the internal combustion engine can get notified in advance of this situation such that the operator takes corrective action by refilling first and second supplies 30 and 40, respectively, to prevent algorithm 200 from entering step 250). In step 250, algorithm 200 can simply stop supplying the gaseous fuel to fuel consumer 20 to prevent damage to compressor 60 whereby the internal combustion engine will stall. Alternatively, the internal combustion engine can continue operating at a derated power below the lower-pressure-threshold power PWR_{LPT} (with the gaseous fuel supplied to the fuel consumer 20 from either or both first supply 30 and second supply 40) until the first and/or second storage pressures P_{S1} and P_{S2}, respectively are too low to operate the internal combustion engine at any power level.

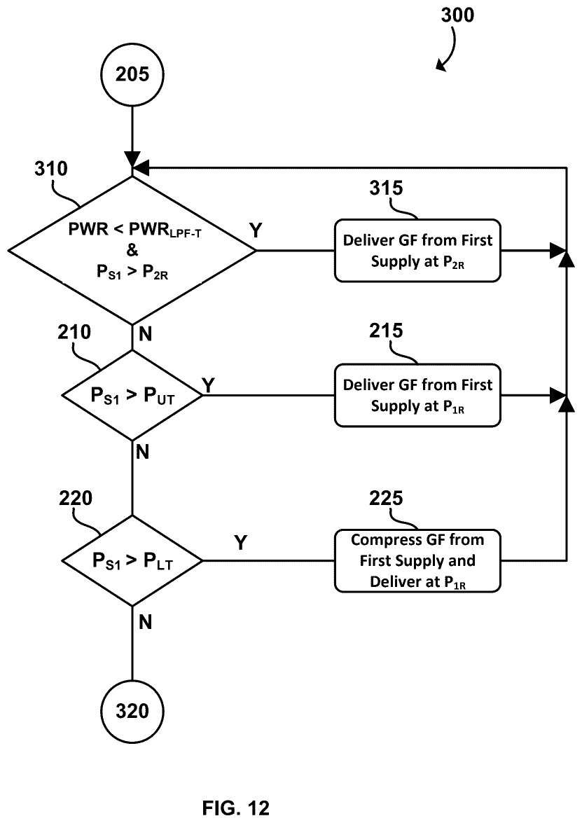

Referring now to FIG. 12 there is shown algorithm 300 that illustrates another technique of operating gaseous-fuel systems 10 to 17, which is like algorithm 200 and only differences are discussed. In the illustrated embodiment, algorithm 300 represents a simplified mode of operation of gaseous-fuel systems 10 to 17 that employs only first supply 30, whereby second supply 40 can simply not be used or can be omitted. In step 205, after the fuel consumer 20 is ready to receive fuel and, for example, the internal combustion engine has started, algorithm 300 proceeds to step 310 instead of step 210 like algorithm 200. In step 310, the conditions that enable a low-pressure flow from first supply 30 are assessed. More particularly, algorithm 200 determines whether the internal combustion engine is operating at a power level (that is, a load on the engine) below a low-pressure-flow threshold power PWR_{LPF-T} and whether the first storage pressure P_{S1} in first supply 30 is above the second regulated pressure P_{2R} such that when these two conditions are true (Y), control is transferred to step 315 where a fifth stage of operation is entered, otherwise control is transferred to step 210 where other previously discussed conditions are evaluated. In an exemplary embodiment the low-pressure-flow threshold power PWR_{LPF-T} can be a mid-load power condition of the internal combustion engine (that is, a power substantially equal to 50% of the maximum rated power); although in other embodiments other engine power levels both higher and lower can be employed. A range of factors may influence the low-pressure-flow threshold power PWR_{LPF-T} such as the type of gaseous fuel and a combustion mode of the internal combustion engine. Various combustion modes are contemplated, including a late-cycle, direct-injection combustion mode (where the gaseous fuel burns with substantially diffusion combustion), a mid-cycle, direct-injection combustion mode (where the gaseous fuel burns with substantially partially-premixed combustion, which includes both diffusion and premixed flame components), and an early-cycle combustion mode (where the gaseous fuel burns with substantially premixed flame combustion, and the gaseous fuel can be either directly injected into an engine cylinder or fumigated through an intake valve). In step 315, controller 130 actuates respective supply-select apparatuses 50 to 57 (seen in FIGS. 1 to 8, respectively) such that the gaseous fuel from first supply 30 is supplied to second pressure regulator 80 whereby the delivery pressure P_{D} of the gaseous fuel supplied to fuel consumer 20 (seen in FIGS. 1 to 8) is the second regulated pressure P_{2R}. More particularly, valve 110 is actuated to the open position in FIGS. 1, 2, and 4 while the other automatically actuatable valves therein are in the closed position; valves 90 and 145 are actuated to the open position in FIGS. 3 and 5 while the other automatically actuatable valves therein are in the closed position; and valves 95, 105, 115, 140, and 155 in FIG. 6 are in the closed position, valve 106 is actuated to the open position in FIG. 7 while the other automatically actuatable valves therein are in the closed position; valve 96, 140, and 155 are in the closed position; and compressor 60 is turned off in all embodiments seen in FIGS. 1 to 8 in the stage defined by step 315. In the illustrated embodiment of FIG. 12, the internal combustion engine can be operated at the second regulated pressure P_{2R} (which is lower than the first regulated pressure P_{1R}) at power levels below the low-pressure-flow threshold power PWR_{LPF-T} without substantial changes to the thermal efficiency of the internal combustion engine compared to operating at the first regulated pressure P_{1R}, particularly but not exclusively when the gaseous fuel is hydrogen. Range extension may be possible the more the internal combustion engine is operated at lower pressure.

Algorithm 300 proceeds to step 210 when the conditions in step 310 are false (N), and when the conditions of step 210 are true (Y), algorithm 300 proceeds to step 215 where a high-pressure flow is supplied to fuel consumer 20 at the first regulated pressure P_{1R} from first supply 30 without compression (the first stage of operation), and when the conditions of step 210 are false (N), algorithm 300 proceeds to step 220. Similarly, when the conditions of step 220 are true (Y), algorithm 300 proceeds to step 225 where a high-pressure flow is supplied to fuel consumer 20 at the first regulated pressure P_{1R} from first supply 30 through compressor 60 (the second stage of operation). However, when the conditions of step 220 are false (N), algorithm 300 proceeds to step 320 instead of step 250 as shown in algorithm 200. Step 320 is like step 250 in algorithm 200, except step 320 represents the circumstance where is only first fuel supply 30, and the first supply cannot supply the gaseous fuel above the lower threshold pressure P_{LT} such that the internal combustion engine cannot be operated at the lower-pressure-threshold power PWR_{LPT} or above. Like step 250, algorithm 300 can simply stop supplying the gaseous fuel to fuel consumer 20 in step 320 or the internal combustion engine can continue to operate at a derated power below the lower-pressure-threshold power PWR_{LPT}. Additionally, algorithm 300 can enable the low-pressure flow through second pressure regulator 80 in step 320, particularly when the power is derated below the low-pressure-flow threshold power PWR_{LPFT}.

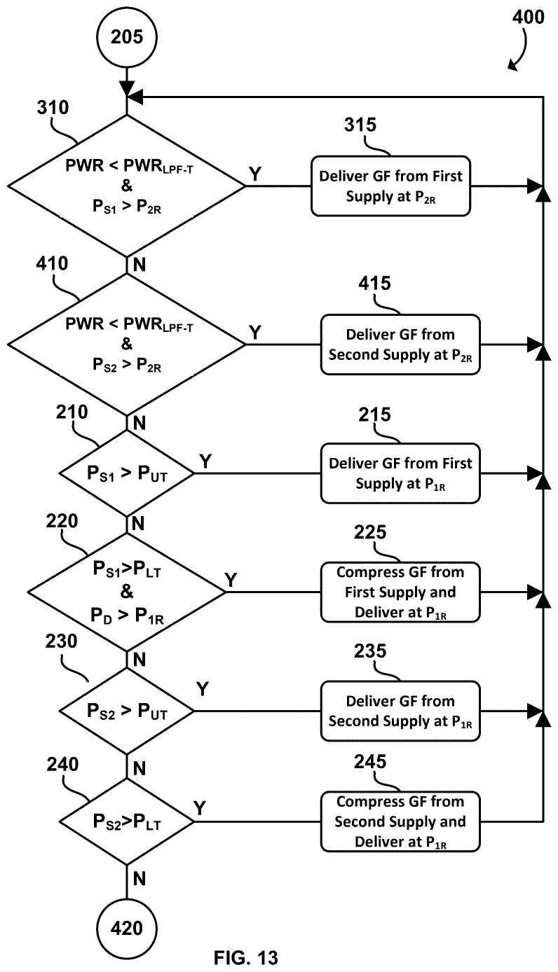

Referring now to FIG. 13 there is shown algorithm 400 that illustrates another technique of operating gaseous-fuel systems 10 to 17, which combines aspects of algorithm 200 and 300 and only differences are discussed. Algorithm 400 is operated with all the components represented in the illustrated embodiments of FIGS. 1 to 8, including second supply 40 and second pressure regulator 80, whereby the gaseous-fuel systems 10 to 17 can supply either a lower-pressure flow or a high-pressure flow of the gaseous fuel from each of first or second supplies 30 and 40, respectively, as will now be discussed. In step 205 algorithm 400 proceeds to step 310 like algorithm 300.

Algorithm 400 begins by testing for conditions that enable a low-pressure flow to fuel consumer 20. In step 310, the conditions for a low-pressure flow from first supply 30 are assessed and when these conditions are met control transfers to step 315 where the fifth stage of operation is entered as previously discussed, otherwise control transfers to step 410 where the conditions for a low-pressure flow from second supply 40 are assessed. More particularly, in step 410 algorithm 400 determines whether the internal combustion engine is operating at a power level below the low-pressure-flow threshold power PWR_{LPF-T} and whether the second storage pressure P_{S2} in second supply 40 is above the second regulated pressure P_{2R} such that when these two conditions are true control is transferred to step 415 where a sixth stage of operation is entered, otherwise control is transferred to step 210 where other previously discussed conditions are evaluated. In step 415, controller 130 actuates respective supply-select apparatuses 50 to 57 (seen in FIGS. 1 to 8, respectively) such that the gaseous fuel from second supply 40 is supplied to second pressure regulator 80 whereby the delivery pressure P_{D} of the gaseous fuel supplied to fuel consumer 20 (seen in FIGS. 1 to 6) is the second regulated pressure P_{2R}. More particularly, valve 115 is actuated to the open position in FIGS. 1, 2, 4, and 6 while the other automatically actuatable valves therein are in the closed position; valves 95 and 145 are actuated to the open position in FIGS. 3 and 5 while the other automatically actuatable valves therein are in the closed position; valve 96 is actuated to the open position in FIGS. 7 and 8 while the other automatically actuatable valves therein are in the closed position; and compressor 60 is turned off in all embodiments seen in FIGS. 1 to 8 in the stage defined by step 415. When the conditions for low-pressure flow are not met in steps 310 and 410, algorithm 400 proceeds to the decision nodes defined by steps 210, 220, 230, and 240, which are each described in detail with respect to algorithm 200 in FIG. 11. Step 210 determines whether the conditions of a high-pressure flow without compression from first supply 30 are met. Step 220 determines whether the conditions of a high-pressure flow through compressor 60 from first supply 30 are met. Step 230 determines whether the conditions of a high-pressure flow without compression from second supply 40 are met. Step 240 determines whether the conditions of a high-pressure flow through compressor 60 from second supply 40 are met. When the conditions of step 240 are not met control transfers to step 420, which is like step 320 discussed with respect to FIG. 8 except in step 420 the internal combustion engine can be operated at a derated power below the lower-pressure-threshold power PWR_{LPT} from the first supply 30 and/or the second supply 40, and algorithm 400 can enable the low-pressure flow through second pressure regulator 80, particularly when the power is derated below the low-pressure-flow threshold power PWR_{LPF-T}.

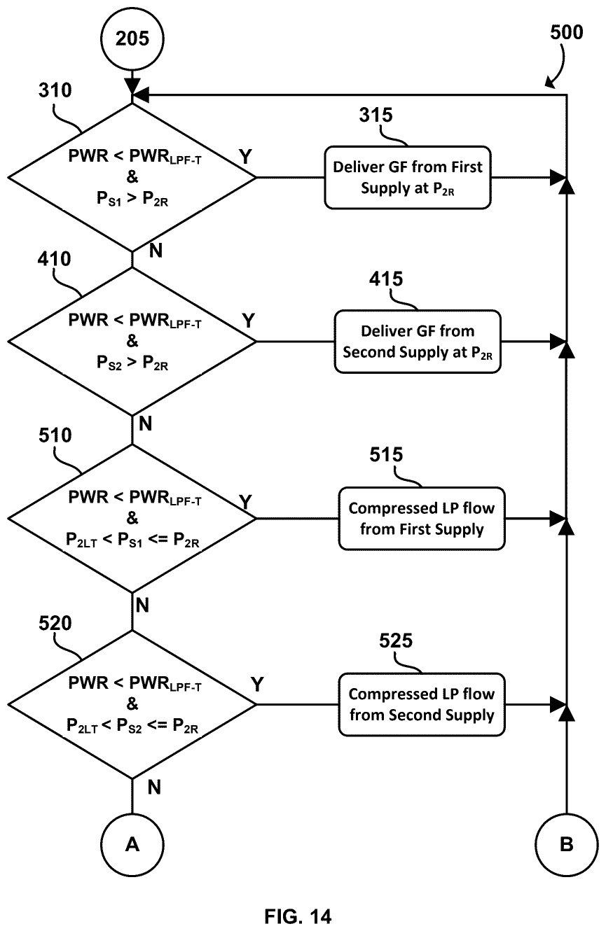

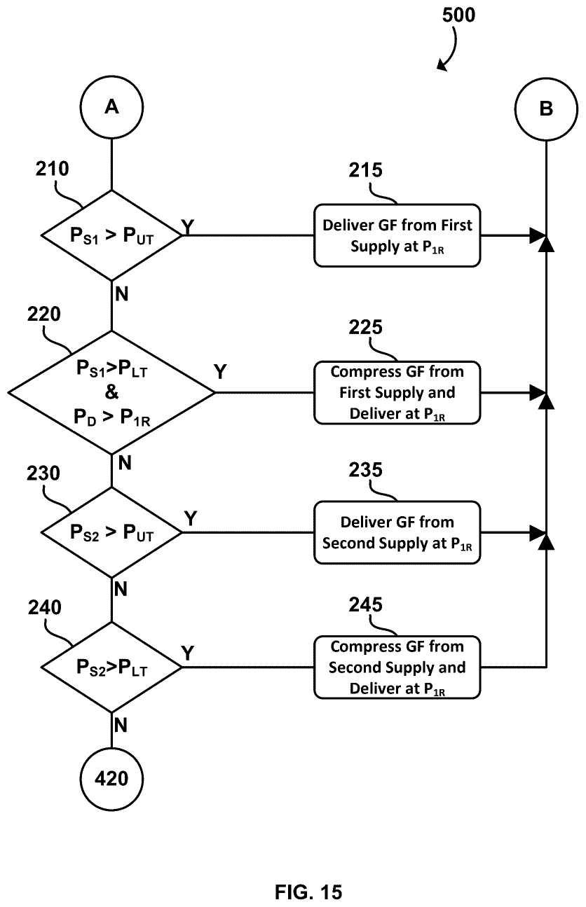

Referring now to FIGS. 14 and 15 there is shown algorithm 500 that illustrates another technique of operating gaseous-fuel systems 11 to 17, which is like algorithm 400 and only differences are discussed. Algorithm 500 introduces decision nodes 510 and 520 between decision node 410 and 210 of algorithm 400. In step 510 the conditions for a low-pressure flow from first supply 30 through compressor 60 are assessed. More particularly, in step 510 algorithm 500 determines whether the internal combustion engine is operating at a power level below the low-pressure-flow threshold power PWR_{LPF-T} and whether the first storage pressure P_{S1} in first supply 30 is above a second lower-threshold pressure P_{2LT} such that when these two conditions are true (Y), control is transferred to step 515 where a seventh stage of operation is entered, otherwise control is transferred to step 520. The second lower-threshold pressure P_{2LT} is primarily determined by the compression ratio of compressor 60 and can be defined as a dividend of the second regulated pressure P_{2R} divided by the compression ratio, which in an exemplary embodiment can be 50 bar (250/5). In step 515, controller 130 actuates respective supply-select apparatuses 51 to 57 (seen in FIGS. 11 to 17, respectively) such that the gaseous fuel from first supply 30 is supplied to inlet 62 of compressor 60, and outlet 64 is fluidly connected to second pressure regulator 80 whereby the delivery pressure P_{D} of the gaseous fuel supplied to fuel consumer 20 is the second regulated pressure P_{2R}. More particularly, valves 100 and 155 are actuated to the open position in FIG. 2 while the other automatically actuatable valves therein are in the closed position; valves 100 and 145 are actuated to the open position in FIGS. 3 and 5 while the other automatically actuatable valves therein are in the closed position; valves 100, 95, and 115 are actuated to the open position in FIG. 4 while the other automatically actuatable valves therein are in the closed position; valve 155 is actuated to the open position in FIGS. 6, 7, and 8 while the other automatically actuatable valves therein are in the closed position; and compressor 60 is turned on in the stage defined by step 515. In step 520 the conditions for a low-pressure flow from second supply 40 through compressor 60 are assessed. More particularly, in step 520 algorithm 500 determines whether the internal combustion engine is operating at a power level below the low-pressure-flow threshold power PWR_{LPF-T} and whether the second storage pressure P_{S2} in second supply 40 is above the second lower-threshold pressure P_{2LT} such that when these two conditions are true control is transferred to step 525 where an eighth stage of operation is entered, otherwise control is transferred to step 210. In step 525, controller 130 actuates respective supply-select apparatuses 51 to 57 (seen in FIGS. 11 to 17, respectively) such that the gaseous fuel from second supply 40 is supplied to inlet 62 of compressor 60, and outlet 64 is fluidly connected to second pressure regulator 80 whereby the delivery pressure P_{D} of the gaseous fuel supplied to fuel consumer 20 is the second regulated pressure P_{2R}. More particularly, valves 105 and 155 are actuated to the open position in FIGS. 2 and 6 while the other automatically actuatable valves therein are in the closed position; valves 105 and 145 are actuated to the open position in FIGS. 3 and 5 while the other automatically actuatable valves therein are in the closed position; valves 105, 95, and 115 are actuated to the open position in FIG. 4 while the other automatically actuatable valves therein are in the closed position; valves 96, 106, and 155 are actuated to the open position in FIG. 7 while the other automatically actuatable valves therein are in the closed position; valves 96 and 155 are actuated to the open position in FIG. 8 while the other automatically actuatable valves therein are in the closed position; and compressor 60 is turned on in the stage defined by step 515. The seventh and eighth stages (that provide a low-pressure flow with compression) each increase the operating range of a vehicle employing the internal combustion engine of fuel consumer 20. In other embodiments, the order of the decision nodes in algorithm 500 can be rearranged. In one such embodiment, the order of the decision nodes can be 310, 510, 410, 520, 210, 220, 230, and 240 that successively determine whether the fifth stage, the seventh stage, the sixth stage, the eighth stage, the first stage, the second stage, the third stage, and the fourth stage, respectively, can be entered. With reference to algorithm 300 seen in FIG. 12, other embodiments can further include decision node 510 between decision nodes 310 and 210 such that a low-pressure flow with compression from the first supply can be employed. The first stage refers to a high-pressure flow without compression from the first supply, the second stage refers to a high-pressure flow with compression from the first supply, the third stage refers to a high-pressure flow without compression from the second supply, the fourth stage refers to a high-pressure flow with compression from the second supply, the fifth stage refers to a low-pressure flow without compression from the first supply, the sixth stage refers to a low-pressure flow without compression from the second supply, the seventh stage refers to a low-pressure flow with compression from the first supply, and the eighth stage refers to a low-pressure flow with compression from the second supply.

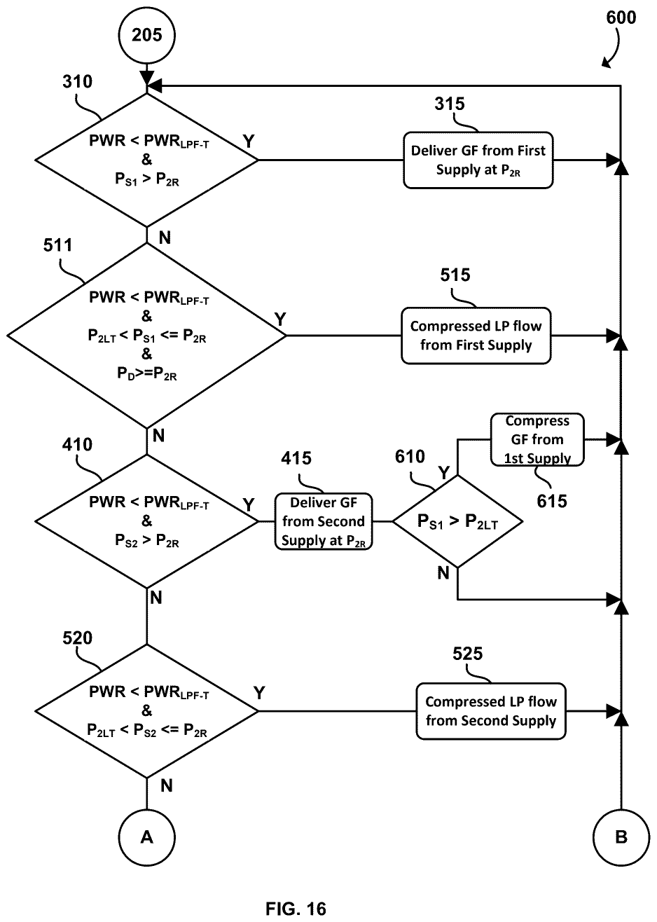

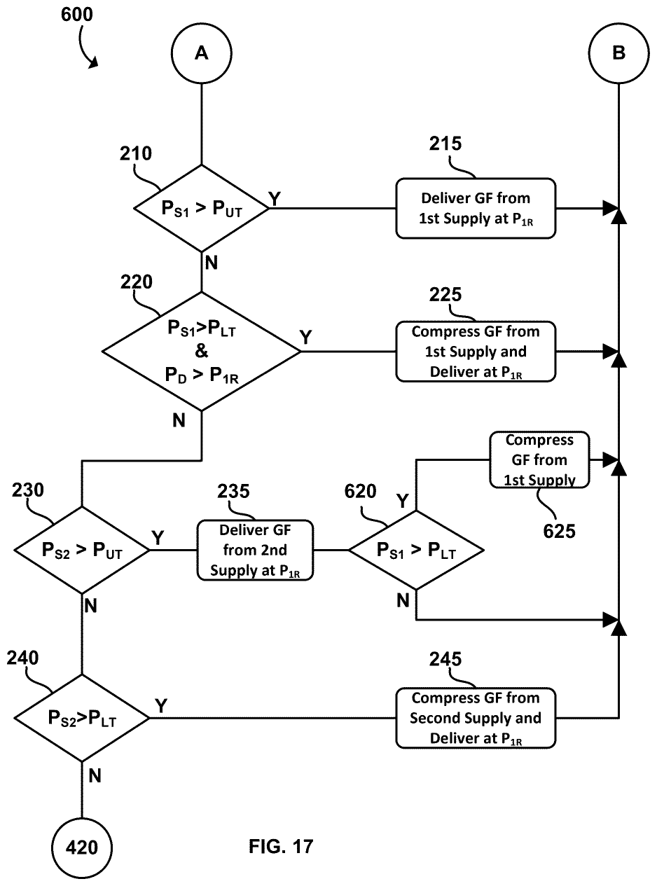

Referring now to FIGS. 16 and 17, there is shown algorithm 600 that illustrates another technique of operating gaseous-fuel systems 11, 12, 14, 15 and 16, which is like algorithm 500 and only differences are discussed. The decision node in step 510 in algorithm 500 has been replaced by step 511 (which is also considered the decision node for determining the seventh stage of operation), where the criteria of the delivery pressure P_{D} being greater than or equal to the second regulated pressure P_{2R} is an additional condition that when true (Y) control transfers to step 515. As the first storage pressure P_{S1} approaches the second lower-threshold pressure P_{2LT}, when compressor 60 is sufficiently undersized at some point the compressor may not be able to provide the mass flow of gaseous fuel demanded by fuel consumer 20, at which point the delivery pressure begins to decrease, and when the delivery pressure P_{D} drops below the second regulated pressure P_{2R}, control transfers to step 410. A second lower-threshold-pressure power PWR_{2LPT} can be defined. The internal combustion engine can operate at and below the second lower-pressure-threshold power PWR_{2LPT} (which is a derated power) when the inlet pressure of compressor 60 is substantially at the second lower-threshold pressure P_{2LT}. A value of the second lower-pressure-threshold power PWR_{2LPT} is a function of the mass flow rate of compressor 60 (which in turn can be a function of the size of the compressor) and the value can be as high as the low-pressure-flow threshold power PWR_{LPF-T} (when the compressor mass flow rate can match the demanded mass flow rate of fuel consumer 20 for operation at the low-pressure-flow threshold power PWR_{LPF-T}) or below the low-pressure-flow threshold power PWR_{LPF-T}. The order of decision nodes in steps 410 and 511 have been swapped in algorithm 600 compared to steps 410 and 510 in algorithm 500. By first drawing from first supply 30 with both a low-pressure flow without and with compression before drawing from second supply 40 with a low-pressure flow without compression preserves the pressure of the second supply longer. There is an opportunity to employ compressor 60 to pressurize the gaseous fuel from first supply 30 during the sixth stage of operation defined by step 415, when there is a low-pressure flow without compression drawn from the second supply 40 through second pressure regulator 80, and during the third stage of operation defined by step 235, when there is a high-pressure flow without compression drawn from second supply 40 through first pressure regulator 70. Referring to the sixth stage of operation in step 415 in FIG. 16, first, after enabling the conditions for the sixth stage of operation in step 415, control transfers to step 610 where the conditions for pressurizing the gaseous fuel from first supply 30 during the sixth stage of operation are assessed. More particularly, algorithm 600 determines in step 610 whether the first storage pressure P_{S1} in first supply 30 is greater than the second lower-threshold pressure P_{2LT}, such that when this condition is true control is transferred to step 615 where a ninth stage of operation is entered, otherwise control goes back to the beginning of algorithm 600 (that is, step 310). In step 615, controller 130 pressurizes gaseous fuel from first supply 30 by enabling gaseous-fuel flow through compressor 60 whereby the pressurized gaseous fuel can simply repressurize an accumulator, such as conduit C10 in FIGS. 2, 6, and 7, conduit C12 in FIG. 3, and conduit C14 in FIG. 5, or can add to the low-pressure flow without compression coming from second supply 40. This can allow more fuel mass to be extracted from first supply 30 thereby improving fuel economy, particularly when the parasitic energy cost of pressurizing the gaseous fuel is less than the energy extracted from the pressurized fuel to operate the internal combustion engine. For example, when the compression ratio of compressor 60 is five (5), the first regulated pressure P_{1R} is 350 bar, and the second regulated pressure P_{2R} is 250 bar, a useable value of the first storage pressure P_{S1} can be reduced from 70 bar to 50 bar. More particularly, for re-pressurization of conduits C10, C12, and C14, in addition to the valves opened in step 415, in step 615 controller 130 actuates valve 100 to the open position in FIGS. 2, 3, and 5; and for combining a low-pressure flow with compression from first supply 30 with the low-pressure flow without compression from second supply 40, in addition to the valves opened in step 415, in step 615 controller 130 actuates valves 100 and 155 to the open position in FIG. 2; actuates valve 100 to the open position in FIGS. 3 and 5; actuates valve 155 to the open position in FIGS. 6 and 7; and compressor 60 is turned on in step 615. Referring now to the third stage of operation in step 235 in FIG. 17, after enabling the conditions for the third stage of operation in step 235, control transfers to step 620 where the conditions for pressurizing the gaseous fuel from first supply 30 during the third stage of operation are assessed. More particularly, algorithm 600 determines in step 620 whether the first storage pressure P_{S1} in first supply 30 is greater than the lower threshold pressure P_{LT}, such that when this condition is true control is transferred to step 625 where a tenth stage of operation is entered, otherwise control goes back to the beginning of algorithm 600 (that is, step 310). In step 625, controller 130 pressurizes gaseous fuel from first supply 30 by enabling gaseous-fuel flow through compressor 60 whereby the pressurized gaseous fuel can simply repressurize the accumulator (or another accumulator), such as conduit C10 in FIGS. 2, 6, and 7, conduit C12 in FIG. 3, and conduit C14 in FIG. 5, or can add to the high-pressure flow coming from second supply 40. More particularly, for re-pressurization of conduits C10, C12, and C14 and for combining a high-pressure flow with compression from first supply 30 with the high-pressure flow without compression from second supply 40, in addition to the valves opened in step 235, in step 625 controller 130 actuates valve 100 to the open position in FIGS. 2, 3, and 5; and compressor 60 is turned on in step 625. For re-pressurization of conduits C10, C12, and C14 when the high-pressure flow without compression is drawn from second supply 40, controller 130 commands compressor 60 to pressurize the conduits whereby pressurized pressure P_{P} is less than the second storage pressure P_{S2}. For the high-pressure flow with compression drawn from first supply 30 to be combined with the high-pressure flow without compression drawn from second supply 40 and the combined flow delivered through first pressure regulator 70 to fuel consumer 20, controller 130 can command compressor 60 to increase the pressurized pressure P_{P} greater than second storage pressure P_{S2}. In all embodiments, during the ninth stage when the low-pressure flow without compression is drawn from second supply 40 and the low-pressure flow with compression is drawn from first supply 30, where the low-pressure flows with and without compression are combined at inlet 82 of second pressure regulator 80, the low-pressure flow with compression can contribute up to 100% of a total low-pressure flow of the gaseous fuel to fuel consumer 20, or in other embodiments up to 75% of the total low-pressure flow, or in further embodiments up to 50% of the total low-pressure flow, or in still further embodiments up to 25% of the total low-pressure flow. The total low-pressure flow of the gaseous fuel to fuel consumer 20 is the combined flow of the low-pressure flow with compression from first supply 30 and the low-pressure flow without compression from second supply 40. In an exemplary embodiment, the average mass flow of the low-pressure flow with compression is substantially 20% of the average mass flow of the total low-pressure flow. Similarly, during a tenth stage when the high-pressure flow without compression is drawn from second supply 40 and the high-pressure flow with compression is drawn from first supply 30, where the high-pressure flows with and without compression are combined at inlet 72 of first pressure regulator 70, the high-pressure flow with compression can contribute up to 100% of a total high-pressure flow of the gaseous fuel to fuel consumer 20, or in other embodiments up to 75% of the total high-pressure flow, or in further embodiments up to 50% of the total high-pressure flow, or in still further embodiments up to 25% of the total high-pressure flow. The total high-pressure flow of the gaseous fuel to fuel consumer 20 is the combined flow of the high-pressure flow with compression from first supply 30 and the high-pressure flow without compression from second supply 40. In an exemplary embodiment the average mass flow of the high-pressure flow with compression is substantially 20% of the average mass flow of the total high-pressure flow.

In all embodiments herein, it is advantageous to fluidly connect (either directly or through valves) outlet 64 of compressor 60 with inlet 72 of first pressure regulator 70 and inlet 82 of second pressure (that is, fluidly connect the compressor outlet upstream of the inlets of the first and second pressure regulators) to avoid having to employ another pressure regulator downstream from the first and second pressure regulators. For example, if outlet 64 of compressor 60 was fluidly connected with outlet 74 of first pressure regulator 70 and outlet 84 of second pressure regulator 80 then yet another high-pressure regulator and low-pressure regulator downstream from outlets 64, 74, and 84 of the compressor, the first pressure regulator, and the second pressure regulator, respectively, would likely be required to properly regulate delivery pressure P_{D} to fuel consumer 20 since the pressurized pressure P_{P} at outlet 64 can experience large swings in instantaneous pressure due to the nature of compressor operation when gaseous fuel mass is ejected from the compressor.

While particular elements, embodiments and applications of the present invention have been shown and described, it will be understood, that the invention is not limited thereto since modifications can be made by those skilled in the art without departing from the scope of the present disclosure, particularly in light of the foregoing teachings.

1. An apparatus for supplying and pressurizing a gaseous fuel to an internal combustion engine comprising
a first supply of the gaseous fuel storing the gaseous fuel as a compressed gas at a first storage pressure;
a compressor comprising an inlet and an outlet, the compressor selectively pressurizing the gaseous fuel at the inlet from the first supply and providing the gaseous fuel at a pressurized pressure at the outlet; and
a first pressure regulator comprising an inlet and an outlet, the inlet configured to fluidly receive the gaseous fuel from the first supply at the first storage pressure or from the compressor at the pressurized pressure, the first pressure regulator regulates a pressure of the gaseous fuel at the inlet to a first regulated pressure at the outlet, the internal combustion engine in fluid communication with the outlet to fluidly receive the gaseous fuel at the first regulated pressure.

2.-4. (canceled)

5. The apparatus as claimed in claim 1, further comprising:
a second supply of the gaseous fuel storing the gaseous fuel as a compressed gas at a second storage pressure;
a second pressure regulator comprising an inlet and an outlet, the inlet of the second pressure regulator configured to fluidly receive the gaseous fuel from the first supply at the first storage pressure or from the compressor at the pressurized pressure, the second pressure regulator regulates a pressure of the gaseous fuel at the inlet to a second regulated pressure at the outlet, the internal combustion engine in fluid communication with the outlet of the second pressure regulator to fluidly receive the gaseous fuel at the second regulated pressure; and
a supply-select apparatus in fluid communication with the first supply and the second supply and actuatable to fluidly connect the first supply and the second supply selectively with the first pressure regulator, the second pressure regulator or the compressor;
a delivery valve configured to selectively enable a flow of gaseous fuel from the first pressure regulator to the internal combustion engine;
wherein the first regulated pressure is greater than the second regulated pressure whereby when the delivery valve is in an open position the first pressure regulator is configured to supply a high-pressure flow to the internal combustion engine and when the delivery valve is in a closed position the second pressure regulator is configured to supply a low-pressure flow to the internal combustion engine.

6. The apparatus as claimed in claim 5, wherein the first storage pressure of the first supply and the second storage pressure of the second supply are both substantially within a range of 350 bar and 700 bar when the first supply and the second supply are filled[[.]]; or
wherein the gaseous fuel is one of biogas, hydrogen, methane, natural gas, and mixtures of these gaseous fuels.

7. The apparatus as claimed in claim 5, wherein the apparatus comprises at least one of:
the first supply comprises one or more gas cylinders;
the second supply comprises one or more gas cylinders; and
a shared gas cylinder selectively fluidly connected to the first supply or the second supply;
wherein a storage volume ratio between a volume of the first supply over a volume of the second supply is one of 1:1, 2:1, 3:1, 4:1, 5:1, 1:2, 1:3, 1:4, 1:5, 3:2, and 2:3.

8.-12. (canceled)

13. The apparatus as claimed in claim 5, comprising a controller operatively connected with the supply-select apparatus, the compressor, and the delivery valve, the controller programmed to,
compare the first storage pressure of the first supply with an upper threshold pressure;
when the first storage pressure of the first supply is greater than the upper threshold pressure,
command a first stage of operation by providing a high-pressure flow of the gaseous fuel without compression from the first supply to the internal combustion engine through the first pressure regulator;
when the first storage pressure of the first supply is less than or equal the upper threshold pressure,
compare the first storage pressure with a lower threshold pressure and compare a delivery pressure with the first regulated pressure;
when the first storage pressure is greater than the lower threshold pressure and the delivery pressure is greater than or equal to the first regulated pressure,
command a second stage of operation by providing a high-pressure flow of the gaseous fuel with compression from the first supply to the internal combustion engine through the compressor and the first pressure regulator;
when the first storage pressure is less than or equal to the lower threshold pressure or the delivery pressure is less than the first regulated pressure,
compare the second storage pressure of the second supply with the upper threshold pressure;
when the second storage pressure is greater than the upper threshold pressure,
command a third stage of operation by providing a high-pressure flow of the gaseous fuel without compression from the second supply to the internal combustion engine through the second pressure regulator;
when the second storage pressure is less than or equal to the upper threshold pressure,
compare the second storage pressure of the second supply with the lower threshold pressure; and
when the second storage pressure is greater than the lower threshold pressure,
command a fourth stage of operation by providing a high-pressure flow of the gaseous fuel with compression from the second supply to the internal combustion engine through the compressor and the first pressure regulator.

14. The apparatus as claimed in claim 13, wherein the upper threshold pressure is a function of a combustion mode of the internal combustion engine and the gaseous fuel, and the lower threshold pressure is a function of a compression ratio of the compressor and the first regulated pressure of the first pressure regulator; or
wherein the first regulated pressure is within a range of 200 bar to 600 bar, and the second regulated pressure is within a range of 50 bar to 300 bar; or
wherein during the second stage of operation providing the high-pressure flow with compression from the first supply or the fourth stage of operation providing the high-pressure flow with compression from the second supply, the compressor is sized whereby the internal combustion engine can operate up to a low-threshold-pressure power, wherein the low-threshold-pressure power is one of:
75% of a maximum rated power of the internal combustion engine;
50% of a maximum rated power of the internal combustion engine; and
25% of a maximum rated power of the internal combustion engine.

15.-16. (canceled)

17. The apparatus as claimed in claim 13, wherein before determining whether the first stage, the second stage, the third stage, and the fourth stage of operation are to be commanded, the controller is further programmed to,
compare a power of the internal combustion engine with a low-pressure-flow threshold power and the first storage pressure of the first supply with the second regulated pressure;
when the power of the internal combustion engine is less than the low-pressure-flow threshold power and the first storage pressure is greater than the second regulated pressure,
command a fifth stage of operation by providing a low-pressure flow of the gaseous fuel without compression from the first supply to the internal combustion engine through the second pressure regulator;
when the power of the internal combustion engine is less than the low-pressure-flow threshold power and the first storage pressure is less than or equal to the second regulated pressure,
compare the second storage pressure of the second supply with the second regulated pressure,
when the second storage pressure of the second supply is greater than the second regulated pressure,
command a sixth stage of operation by providing a low-pressure flow of the gaseous fuel without compression from the second supply to the internal combustion engine through the second pressure regulator.

18. The apparatus as claimed in claim 17, wherein after determining whether the fifth stage and the sixth stage of operation are to be commanded and before determining whether the first stage, the second stage, the third stage, and the fourth stage of operation are to be commanded, the controller is further programmed to,
when the power of the internal combustion engine is less than the low-pressure-flow threshold power and the second storage pressure is less than or equal to the second regulated pressure,
compare the first storage pressure with a second lower-threshold pressure;
when the first storage pressure is greater than the second lower-threshold pressure,
command a seventh stage of operation by providing a low-pressure flow of the gaseous fuel with compression from the first supply to the internal combustion engine through the compressor and the second pressure regulator;
when the power of the internal combustion engine is less than the low-pressure-flow threshold power and the first storage pressure is less than or equal to the second lower-threshold pressure,
compare the second storage pressure with the second lower-threshold pressure; and
when the second storage pressure is greater than the second lower-threshold pressure,
command an eighth stage of operation by providing a low-pressure flow of the gaseous fuel with compression from the second supply to the internal combustion engine through the compressor and the second pressure regulator.

19. The apparatus as claimed in claim 17, wherein after determining whether the fifth stage of operation is to be commanded and before determining whether the sixth stage, the first stage, the second stage, the third stage, and the fourth stage of operation are to be commanded, the controller is further programmed to,
when the power of the internal combustion engine is less than the low-pressure-flow threshold power and the second storage pressure is less than or equal to the second regulated pressure,
compare the first storage pressure with a second lower-threshold pressure;
when the first storage pressure is greater than the second lower-threshold pressure,
command a seventh stage of operation by providing a low-pressure flow of the gaseous fuel with compression from the first supply to the internal combustion engine through the compressor and the second pressure regulator.

20. The apparatus as claimed in claim 19, wherein after determining whether the fifth stage, the seventh stage, and the sixth stage of operation are to be commanded and before determining whether the first stage, the second stage, the third stage, and the fourth stage of operation are to be commanded, the controller is further programmed to,
when the power of the internal combustion engine is less than the low-pressure-flow threshold power and the first storage pressure is less than or equal to the second lower-threshold pressure,
compare the second storage pressure with the second lower-threshold pressure; and
when the second storage pressure is greater than the second lower-threshold pressure,
command an eighth stage of operation by providing a low-pressure flow of the gaseous fuel with compression from the second supply to the internal combustion engine through the compressor and the second pressure regulator.

21. The apparatus as claimed in claim 17, wherein when the sixth stage of operation is commanded, the controller is further programmed to,
compare the first storage pressure with a second lower-threshold pressure; and
when the first storage pressure is greater than the second lower-threshold pressure,
command a ninth stage of operation by providing a low-pressure flow of the gaseous fuel with compression from the first supply to the internal combustion engine through the compressor and the second pressure regulator and combining with the low-pressure flow of the gaseous fuel without compression from the second supply to the internal combustion engine through the second pressure regulator commanded in the sixth stage of operation.

22. The apparatus as claimed in claim 21, wherein during the ninth stage of operation the low-pressure flow of the gaseous fuel with compression from the first supply comprises up to one of:
100% of a total flow of the gaseous fuel to the internal combustion engine;
75% of the total flow of the gaseous fuel to the internal combustion engine;
50% of the total flow of the gaseous fuel to the internal combustion engine; and
25% of the total flow of the gaseous fuel to the internal combustion engine;
wherein the total flow of the gaseous fuel is a combined flow of the low-pressure flow with compression from the first supply and the low-pressure flow without compression from the second supply; and/or
wherein the second lower-threshold pressure is a function of a compression ratio of the compressor and the second regulated pressure of the second pressure regulator.

23.-24. (canceled)

25. The apparatus as claimed in claim 13, wherein when the third stage of operation is commanded, the controller is further programmed to,
compare the first storage pressure with the lower threshold pressure; and
when the first storage pressure is greater than the lower threshold pressure,
command a tenth stage of operation by providing a high-pressure flow of the gaseous fuel with compression from the first supply to the internal combustion engine through the compressor and the first pressure regulator and combining with the high-pressure flow of the gaseous fuel without compression from the second supply to the internal combustion engine through the first pressure regulator commanded in the third stage of operation; or
compare the first storage pressure with the lower threshold pressure; and
when the first storage pressure is greater than the lower threshold pressure,
command a tenth stage of operation by pressurizing gaseous fuel drawn from the first supply into a conduit in fluid communication with the outlet of the compressor.

26. The apparatus as claimed in claim 25, wherein during the tenth stage of operation the high-pressure flow of the gaseous fuel with compression from the first supply comprises up to one of:
100% of a total flow of the gaseous fuel to the internal combustion engine;
75% of the total flow of the gaseous fuel to the internal combustion engine;
50% of the total flow of the gaseous fuel to the internal combustion engine; and
25% of the total flow of the gaseous fuel to the internal combustion engine,
wherein the total flow of the gaseous fuel is a combined flow of the high-pressure flow with compression from the first supply and the high-pressure flow without compression from the second supply.

27.-28. (canceled)

29. The apparatus as claimed in claim wherein the controller is further programmed to
actuate the shared gas cylinder to selectively fluidly connect to the first supply or the second supply to set the storage volume ratio between a volume of the first supply over a volume of the second supply as a function of any one or more of:
a. a determined duty cycle for the engine,
b. an operator preference,
c. a learned operator pattern, and
d. a system use pattern; and/or
actuate the shared gas cylinder to selectively fluidly connect to the first supply or the second supply to set the storage volume ratio between a volume of the first supply over a volume of the second supply as a function of any one or more of:
e. a distance to a high load requirement,
f. a distance to a geographical location,
g. a distance to system shut down, and
h. a distance to system refueling; and/or
actuate the shared gas cylinder to selectively fluidly connect to the first supply or the second supply to set the storage volume ratio between a volume of the first supply over a volume of the second supply as a function of any one or more of:
i. a time to a high load requirement,
j. a time to a geographical location,
k. a time to system shut down, and
l. a time to system refueling.

30.-31. (canceled)

32. The apparatus as claimed in claim 13, wherein the controller is further programmed to select an order of each stage of operation to optimize for a determined duty cycle for the engine.

33. A method for supplying and pressurizing a gaseous fuel to an internal combustion engine comprising
storing the gaseous fuel in a first supply as a compressed gas at a first storage pressure;
storing the gaseous fuel in a second supply as a compressed gas at a second storage pressure;
comparing the first storage pressure of the first supply with an upper threshold pressure;
when the first storage pressure of the first supply is greater than the upper threshold pressure,
commanding a first stage of operation by providing a high-pressure flow of the gaseous fuel without compression from the first supply to the internal combustion engine;
when the first storage pressure of the first supply is less than or equal the upper threshold pressure,
comparing the first storage pressure with a lower threshold pressure and comparing a delivery pressure of the gaseous fuel to the internal combustion engine with a first regulated pressure;
when the first storage pressure is greater than the lower threshold pressure and the delivery pressure is greater than or equal to the first regulated pressure,
commanding a second stage of operation by providing a high-pressure flow of the gaseous fuel with compression from the first supply to the internal combustion engine;
when the first storage pressure is less than or equal to the lower threshold pressure or the delivery pressure is less than the first regulated pressure,
comparing the second storage pressure of the second supply with the upper threshold pressure;
when the second storage pressure is greater than the upper threshold pressure,
commanding a third stage of operation by providing a high-pressure flow of the gaseous fuel without compression from the second supply to the internal combustion engine;
when the second storage pressure is less than or equal to the upper threshold pressure,
comparing the second storage pressure of the second supply with the lower threshold pressure; and
when the second storage pressure is greater than the lower threshold pressure,
commanding a fourth stage of operation by providing a high-pressure flow of the gaseous fuel with compression from the second supply to the internal combustion engine.

34.-36. (canceled)

37. The method as claimed in claim 33, wherein before determining whether the first stage, the second stage, the third stage, and the fourth stage of operation are to be commanded, the method further comprises
comparing a power of the internal combustion engine with a low-pressure-flow threshold power and the first storage pressure of the first supply with the second regulated pressure;
when the power of the internal combustion engine is less than the low-pressure-flow threshold power and the first storage pressure is greater than the second regulated pressure,
commanding a fifth stage of operation by providing a low-pressure flow of the gaseous fuel without compression from the first supply to the internal combustion engine;
when the power of the internal combustion engine is less than the low-pressure-flow threshold power and the first storage pressure is less than or equal to the second regulated pressure,
comparing the second storage pressure of the second supply with the second regulated pressure,
when the second storage pressure of the second supply is greater than the second regulated pressure,
commanding a sixth stage of operation by providing a low-pressure flow of the gaseous fuel without compression from the second supply to the internal combustion engine.

38. The method as claimed in claim 37, wherein after determining whether the fifth stage and the sixth stage of operation are to be commanded and before determining whether the first stage, the second stage, the third stage, and the fourth stage of operation are to be commanded, the method further comprises
when the power of the internal combustion engine is less than the low-pressure-flow threshold power and the second storage pressure is less than or equal to the second regulated pressure,
comparing the first storage pressure with a second lower-threshold pressure;
when the first storage pressure is greater than the second lower-threshold pressure,
commanding a seventh stage of operation by providing a low-pressure flow of the gaseous fuel with compression from the first supply to the internal combustion engine;
when the power of the internal combustion engine is less than the low-pressure-flow threshold power and the first storage pressure is less than or equal to the second lower-threshold pressure,
comparing the second storage pressure with the second lower-threshold pressure; and
when the second storage pressure is greater than the second lower-threshold pressure,
commanding an eighth stage of operation by providing a low-pressure flow of the gaseous fuel with compression from the second supply to the internal combustion engine; or
wherein after determining whether the fifth stage of operation is to be commanded and before determining whether the sixth stage, the first stage, the second stage, the third stage, and the fourth stage of operation are to be commanded, the method further comprises,
when the power of the internal combustion engine is less than the low-pressure-flow threshold power and the first storage pressure is less than or equal to the second regulated pressure,
comparing the first storage pressure with a second lower-threshold pressure; and
when the first storage pressure is greater than the second lower-threshold pressure,
commanding a seventh stage of operation by providing a low-pressure flow of the gaseous fuel with compression from the first supply to the internal combustion engine.

39. (canceled)

40. The method as claimed in claim 38, wherein after determining the fifth stage, the seventh stage, and the sixth stage of operation are to be commanded and before determining whether the first stage, the second stage, the third stage, and the fourth stage of operation are to be commanded, the method further comprises
when the power of the internal combustion engine is less than the low-pressure-flow threshold power and the first storage pressure is less than or equal to the second lower-threshold pressure,
comparing the second storage pressure with the second lower-threshold pressure; and
when the second storage pressure is greater than the second lower-threshold pressure,
commanding an eighth stage of operation by providing a low-pressure flow of the gaseous fuel with compression from the second supply to the internal combustion engine.

41. The method as claimed in claim 37, wherein when the sixth stage of operation is commanded, further comprising
comparing the first storage pressure with a second lower-threshold pressure; and
when the first storage pressure is greater than the second lower-threshold pressure,
commanding a ninth stage of operation by providing a low-pressure flow of the gaseous fuel with compression from the first supply to the internal combustion engine and combining with the low-pressure flow of the gaseous fuel without compression from the second supply to the internal combustion engine commanded in the sixth stage of operation; or
comparing the first storage pressure with a second lower-threshold pressure; and
when the first storage pressure is greater than the second lower-threshold pressure,
commanding a ninth stage of operation by pressurizing gaseous fuel drawn from the first supply into a conduit.

42.-44. (canceled)

45. The method as claimed in claim 33, wherein when the third stage of operation is commanded, further comprising
comparing the first storage pressure with the lower threshold pressure; and
when the first storage pressure is greater than the lower threshold pressure,
commanding a tenth stage of operation by providing a high-pressure flow of the gaseous fuel with compression from the first supply to the internal combustion engine and combining with the high-pressure flow of the gaseous fuel without compression from the second supply to the internal combustion engine commanded in the third stage of operation; or
comparing the first storage pressure with the lower threshold pressure; and
when the first storage pressure is greater than the lower threshold pressure,
commanding a tenth stage of operation by pressurizing gaseous fuel drawn from the first supply into a conduit.

46.-47. (canceled)

48. The method as claimed in claim 33, further comprising
commanding an order of each stage of operation as a function of any one or more of:
(a) a determined duty cycle for the engine,
(b) an operator preference,
(c) a learned operator pattern, and
(d) a system use pattern; and/or
actuating a valve fluidly connecting a shared gas cylinder to selectively fluidly connect the shared gas cylinder to a first supply or a second supply thereby setting a storage volume ratio between a volume of the first supply over a volume of the second supply as a function of any one or more of:
(e) a determined duty cycle for the engine,
(f) an operator preference,
(g) a learned operator pattern, and
(h) a system use pattern; and/or
actuating a valve fluidly connecting a shared gas cylinder to selectively fluidly connect the shared gas cylinder to a first supply or a second supply thereby setting a storage volume ratio between a volume of the first supply over a volume of the second supply as a function of any one or more of:
(i) a distance to a high load requirement,
(j) a distance to a geographical location,
(k) a distance to system shut down, and
(l) a distance to system refueling; and/or
actuating a valve fluidly connecting a shared gas cylinder to selectively fluidly connect the shared gas cylinder to a first supply or a second supply thereby setting a storage volume ratio between a volume of the first supply over a volume of the second supply as a function of any one or more of:
(m)a time to a high load requirement,
(n) a time to a geographical location,
(o) a time to system shut down, and
(p) a time to system refueling.

49.-51. (canceled)
